(19) United States
(12) Patent Application Publication
(10) Pub. No.: US 2009/0041352 A1
(43) Pub. Date: Feb. 12, 2009

(54) IMAGE FORMATION DEVICE, IMAGE FORMATION METHOD, AND COMPUTER-READABLE RECORDING MEDIUM RECORDING IMAGE FORMATION PROGRAM

(76) Inventor: Naoki Okamoto, Tenri-shi (JP)

Correspondence Address: BIRCH STEWART KOLASCH & BIRCH, PO BOX 747, FALLS CHURCH, VA, 22040-0747, US

(21) Appl. No.: 12/187,563

(22) Filed: Aug. 7, 2008

(30) Foreign Application Priority Data
Aug. 10, 2007 (JP) 2007-209686(P)
Jun. 30, 2008 (JP) 2008-171148(P)

(51) Int. Cl. G06K 9/34

(52) U.S. Cl. 382/176

(57) ABSTRACT

An image formation device includes an obtaining unit obtaining an input image and a first reduction scale, a first extraction unit extracting a first region including a character from the input image, a first setting unit setting a second reduction scale greater than the first reduction scale when a size of the reduced character is smaller than a first size, and a formation unit forming a second processed image by reducing the first region at the second reduction scale when the size of the character is smaller than the first size.

This nonprovisional application is based on Japanese Patent Applications Nos. 2007-209686 and 2008-171148 filed with the Japan Patent Office on Aug. 10, 2007 and Jun. 30, 2008 respectively, the entire contents of which are hereby incorporated by reference.

### FIELD OF THE INVENTION

The present invention relates to an image formation device, an image formation method, and a computer-readable recording medium recording an image formation program, for editing an input image and outputting the resultant image, and particularly to an image formation device, an image formation method, and a computer-readable recording medium recording an image formation program, for outputting characters included in an image in such a manner that a reader can easily recognize the same.

### DESCRIPTION OF THE BACKGROUND ART

Comic strips have conventionally been distributed to the market as comic books in which comic strips are printed on paper. Recently, service to form electronic comic strips in a form of electronic data based on comic strips on paper and to provide the electronic comic strips to a small-sized terminal such as a portable phone has been supplied. The small-sized terminal displays the provided electronic comic strips.

It is difficult, however, for the small-sized terminal to reproduce such electronic comic strips in a horizontal and vertical size similar to comic materials on paper, because of limited capability thereof As it is difficult for the small-sized terminal to reproduce the electronic comic strips in large size, a provider of the service described above should form again viewable images by reducing the size or adjusting the shape of the comic strips. The formed images are so small that characters in a balloon are hard for readers to read. Therefore, the technique to solve such a problem has been proposed.

Japanese Patent Laying-Open No. 2002-279398 discloses a comic browser including a comic content data storage unit, a comic page image display unit, and image expansion and display means. The comic content data storage unit stores page data and related image data related to a comic frame image. The page data represents a comic page image of at least one page including at least one comic frame image. The comic page image display unit displays the comic page image represented by the page data on a display screen of a display device. The image expansion and display unit expands at least a part of the comic frame image included in the comic page image displayed on the display screen by the comic page image display unit based on the related image data, and displays the expanded image in a manner superimposed on that part.

According to the technique disclosed in Japanese Patent Laying-Open No. 2002-279398, the comic page image is displayed on the display screen and a part of the frame image included in the page image is expanded for display, so that the comic strips can be displayed on the display screen in such a manner that that a reader (viewer) can easily read the same.

Japanese Patent Laying-Open No. 2006-139710 discloses a still comic strip reproduction method for reproducing information such as news through still comic strips on a portable phone or a portable terminal. According to the still comic strip reproduction method, the following two steps are alternately repeated as many times as the number of frames. In the first step, downloaded data is recorded in a storage device. In the second step, image data is reproduced based on the data recorded in the storage device, and after a prescribed time has passed, the data is reproduced with character data being superimposed on the image data. Here, the still comic strips include one or more frames, and in addition, each frame of the still comic strips includes data constituted of character data corresponding to characters in a balloon and image data.

According to the technique disclosed in Japanese Patent Laying-Open No. 2006-139710, as it is not necessary to set unduly high image resolution of the still comic strips, still comic strips can readily be recognized in its entirety with a small amount of information.

On the other hand, the technique disclosed in Japanese Patent Laying-Open No. 2002-279398 has such drawbacks that severe restriction is imposed on a terminal in displaying an image. In particular, an information storage capacity, a processing function, a processing speed, or the like is highly restricted. Such severe restriction results from a considerably large amount of data for displaying one image. The amount of data is large, because resolution of the comic page image should be high.

In addition to the problem above, the technique disclosed in Japanese Patent Laying-Open No. 2006-139710 has such drawbacks that enormous efforts are required to form image data. Restriction on performance is severe in the technique disclosed in Japanese Patent Laying-Open No. 2006-139710, because not only image data itself but also character data should be included. Enormous efforts are required for forming image data, because various types of information (characters and images) originally included in one image should be reconstructed.

The present invention was made to solve the above-described problems, and an object of the present invention is to provide an image formation device, an image formation method, and a computer-readable recording medium recording an image formation program, capable of outputting characters included in an image in such a manner that a reader can easily recognize the same, without enormous efforts to form input image data.

### SUMMARY OF THE INVENTION

In summary, in order to achieve the object above an image formation device according to one aspect of the present invention includes: an obtaining unit obtaining an input image and a first reduction scale; a first extraction unit extracting a first region including a character from the input image; a first determination unit determining whether a size of the character reduced at the first reduction scale is equal to or greater than a first size; a first setting unit setting a second reduction scale greater than the first reduction scale when the size of the character is smaller than the first size; and a formation unit forming a first processed image by reducing the input image at the first reduction scale when the size of the character is equal to or greater than the first size and forming a second processed image by reducing the first region at the second reduction scale based on the input image when the size of the character is smaller than the first size.

Preferably, the image formation device further includes a first calculation unit calculating the size of the character. The first calculation unit includes a generation unit generating a histogram of color distribution in at least any of a horizontal direction and a vertical direction of the first region, a second calculation unit calculating at least any of a width and a height of the character within the first region based on the histogram, and a second setting unit setting at least any of the width and the height of the character within the first region as the size of the character.

Preferably, the image formation device further includes a third calculation unit calculating the size of the character. The third calculation unit includes an area calculation unit calculating an area of the first region, a character recognition unit recognizing the character within the first region, a counting unit counting the number of characters recognized by the character recognition unit, and a division unit dividing the area by the number of the characters to calculate the size of the character.

Preferably, when the size of the character is smaller than the first size, the formation unit forms the second processed image by reducing the first region at the second reduction scale and reducing the input image except for the first region at any of the first reduction scale and the second reduction scale.

Preferably, the first setting unit sets a third reduction scale greater than the first reduction scale when the size of the character is smaller than the first size. When the size of the character is smaller than the first size, the formation unit forms the second processed image by reducing the first region at the second reduction scale and reducing the input image except for the first region at the third reduction scale.

According to another aspect of the present invention, an image formation method is provided. The image formation method includes the steps of: obtaining an input image and a first reduction scale; extracting a first region including a character from the input image; determining whether a size of the character reduced at the first reduction scale is equal to or greater than a first size; setting a second reduction scale greater than the first reduction scale when the size of the character is smaller than the first size; forming a first processed image by reducing the input image at the first reduction scale when the size of the character is equal to or greater than the first size; and forming a second processed image by reducing the first region at the second reduction scale based on the input image when the size of the character is smaller than the first size.

Preferably, the image formation method further includes the steps of generating a histogram of color distribution in at least any of a horizontal direction and a vertical direction of the first region, calculating at least any of a width and a height of the character within the first region based on the histogram, and setting at least any of the width and the height of the character within the first region as the size of the character.

Preferably, the image formation method further includes the steps of calculating an area of the first region, recognizing the character within the first region, counting the number of characters recognized in the step of recognizing the character, and dividing the area by the number of the characters to calculate the size of the character.

Preferably, the step of forming a second processed image includes the step of forming the second processed image by reducing the first region at the second reduction scale and reducing the input image except for the first region at any of the first reduction scale and the second reduction scale when the size of the character is smaller than the first size.

Preferably, the image formation method further includes the step of a setting third reduction scale greater than the first reduction scale when the size of the character is smaller than the first size. The step of forming a second processed image includes the step of forming the second processed image by reducing the first region at the second reduction scale and reducing the input image except for the first region at the third reduction scale, when the size of the character is smaller than the first size.

According to another aspect of the present invention, a computer-readable recording medium recording an image formation program for causing an image formation device having an operational processing unit to form an image is provided. The image formation program causes the operational processing unit to perform the steps of: obtaining an input image and a first reduction scale; extracting a first region including a character from the input image; determining whether a size of the character reduced at the first reduction scale is equal to or greater than a first size; setting a second reduction scale greater than the first reduction scale when the size of the character is smaller than the first size; forming a first processed image by reducing the input image at the first reduction scale when the size of the character is equal to or greater than the first size; and forming a second processed image by reducing the first region at the second reduction scale based on the input image when the size of the character is smaller than the first size.

The foregoing and other objects, features, aspects and advantages of the present invention will become more apparent from the following detailed description of present invention when taken in conjunction with the accompanying drawings.

### BRIEF DESCRIPTION OF THE DRAWINGS

FIG. 1 is a diagram showing a configuration of a comic image formation device according to a first embodiment of the present invention.

FIG. 2 is a functional block diagram of the comic image formation device according to the first embodiment of the present invention.

FIG. 3 is a conceptual diagram showing an exemplary comic image stored as input image data according to the first embodiment of the present invention.

FIG. 4 is a conceptual diagram showing a histogram generated based on an image of a text region.

FIG. 5 is a functional block diagram of a reduction scale setting unit according to the first embodiment of the present invention.

FIG. 6 is a functional block diagram of a trial-based setting unit according to the first embodiment of the present invention.

FIG. 7 is a functional block diagram of an image processing unit according to the first embodiment of the present invention,

FIG. 8 is a flowchart showing a procedure for controlling processing for forming a processed image in the comic image formation device according to the first embodiment of the present invention.

FIG. 9 is a second flowchart showing a procedure for controlling processing for generating a processed image in the comic image formation device according to the first embodiment of the present invention.

FIG. 10 is a flowchart showing a procedure for controlling processing for calculating a text size according to the first embodiment of the present invention.

FIG. 11 is a diagram showing relation between input data and data stored in a data storage unit according to the first embodiment of the present invention.

FIG. 12 is a first flowchart showing a procedure for controlling processing for setting a reduction scale according to the first embodiment of the present invention.

FIG. 13 is a second flowchart showing a procedure for controlling processing for setting a reduction scale according to the first embodiment of the present invention.

FIG. 14 is a third flowchart showing a procedure for controlling processing for setting a reduction scale according to the first embodiment of the present invention.

FIG. 15 is a flowchart showing a procedure for controlling processing for setting a balloon region reduction scale RFn according to the first embodiment of the present invention.

FIG. 16 is a conceptual diagram showing a determination method for setting a text region reduction scale RTn.

FIG. 17 is a conceptual diagram showing a determination method for setting balloon region reduction scale RFn according to the first embodiment of the present invention.

FIG. 18 is a conceptual diagram showing bit map data of a balloon region formed in the first embodiment of the present invention.

FIG. 19 is a first conceptual diagram showing a determination method for setting a comic image reduction scale according to the first embodiment of the present invention.

FIG. 20 is a second conceptual diagram showing a determination method for setting a comic image reduction scale according to the first embodiment of the present invention.

FIG. 21 is a third conceptual diagram showing a determination method for setting a comic image reduction scale according to the first embodiment of the present invention.

FIG. 22 is a conceptual diagram showing processing for matching an end of the balloon region with an end of a reduced comic image according to the first embodiment of the present invention.

FIG. 23 is a fourth conceptual diagram showing a determination method for setting a comic image reduction scale according to the first embodiment of the present invention.

FIG. 24 is a conceptual diagram showing a first variation of the first embodiment of the present invention.

FIG. 25 is a conceptual diagram showing a determination method according to a second variation of the first embodiment of the present invention.

FIG. 26 is a conceptual diagram showing bit map data of a text region formed in the second variation of the first embodiment of the present invention.

FIG. 27 is a conceptual diagram showing a determination method according to a third variation of the first embodiment of the present invention.

FIG. 28 is a first flowchart showing a procedure for controlling processing for generating a processed image according to a second embodiment of the present invention.

FIG. 29 is a second flowchart showing a procedure for controlling processing for generating edited data according to the second embodiment of the present invention.

FIG. 30 is a functional block diagram showing a variation of a text size calculation unit according to the first and second embodiments of the present invention.

FIG. 31 is a flowchart showing a variation of the procedure for controlling processing for calculating a text size according to the first and second embodiments of the present invention.

### DESCRIPTION OF THE PREFERRED EMBODIMENTS

An embodiment of the present invention will be described hereinafter with reference to the drawings. In the description below, the same elements have the same reference characters allotted, and where their labels and functions are identical, detailed description thereof will not be repeated.

### First Embodiment

A comic image formation device according to the first embodiment of the present invention will be described hereinafter.

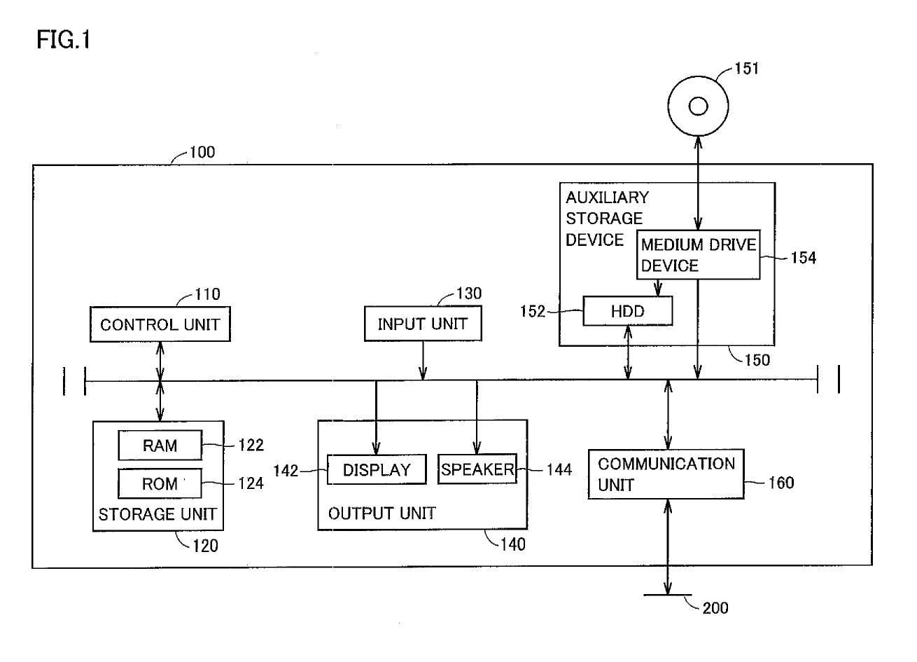

FIG. 1 is a block diagram showing an overall configuration of a comic image formation device 100 in the present embodiment.

Referring to FIG. 1, comic image formation device 100 in the present embodiment includes a control unit 110, a storage unit 120, an input unit 130, an output unit 140, an auxiliary storage device 150, and a communication unit 160.

Control unit 110 is implemented by an MPU (Micro Processing Unit) and an MPU auxiliary circuit. Control unit 110 controls entire comic image formation device 100. Namely, control unit 110 controls storage unit 120, input unit 130, output unit 140, auxiliary storage device 150, and communication unit 160. Control unit 110 performs prescribed processing in accordance with a program or data stored in storage unit 120. According to this processing, data input from input unit 130, auxiliary storage device 150, or communication unit 160 is processed. Control unit 110 causes storage unit 120 to store data processed by control unit 110 itself, or outputs the data to output unit 140, auxiliary storage device 150, or communication unit 160.

Storage unit 120 stores prescribed information. Specific information stored in storage unit 120 will be described later.

Storage unit 120 includes a RAM (Random Access Memory) 122 and a ROM (Read Only Memory) 124. RAM 122 is used as a work area necessary for control unit 110 to execute a program. ROM 124 stores a program to be executed by control unit 110. It is noted that the program to be executed by control unit 110 may be stored in RAM 122 instead of ROM 124. When RAM 122 stores such a program, the program is read through auxiliary storage device 140 or communication unit 160.

Input unit 130 serves as an interface for inputting prescribed information to comic image formation device 100. In the present embodiment, input unit 130 is implemented by a keyboard, a mouse, and a touch screen (none of which is shown). Generation of a signal from such a component in response to an operation by a user allows input of information. Here, the prescribed information refers to information necessary for comic image formation device 100 to edit comic image data. In addition, in the present embodiment, the prescribed information refers to input data which will be described later or information representing graphics in an image displayed by the output unit.

Output unit 140 serves as an interface for outputting images or voice and sound from comic image formation device 100. Output unit 140 includes a display 142 implemented by a liquid crystal display (LCD) device and a speaker 144. Output of a signal from control unit 110 or the like to such a component causes the component to output images or voice and sound.

Auxiliary storage device 150 stores information as an auxiliary storage for RAM 122. In addition, auxiliary storage device 150 also serves as a device reading from a recording medium 15l a program to be executed by control unit 110. Auxiliary storage device 150 includes an HDD (Hard Disk Drive) 152 and a medium drive device 154. HDD 152 reads information recorded on a not-shown magnetic disk or has the magnetic disk record information. Medium drive device 154 reads information recorded on recording medium 151 or has recording medium 151 record necessary information. Medium drive device 154 reads a program or data recorded on recording medium 151 and transmits the program or data to control unit 110. Medium drive device 154 writes necessary data in recording medium 151 in response to an instruction from control unit 110.

Recording medium 151 is a computer-readable recording medium carrying a program in a non-volatile manner, that is implemented by a magnetic tape, a cassette tape, a magnetic disk such as a floppy (registered trademark) disk and a hard disk, an optical disk such as a CD-ROM (Compact Disk Read Only Memory) and a DVD (Digital Versatile Disk), a magneto-optical disk such as an MO (Magneto Optical disk) and an MD (Mini Disc), a memory card such as an IC card and an optical card, or a semiconductor memory such as a mask ROM, an EPROM (Erasable Programmable Read Only Memory), an EEPROM (Electronically Erasable and Programmable Read Only Memory), and a flash ROM.

Communication unit 160 is connected to a wired or wireless network 200 to communicate with other computers connected to network 200. Communication unit 160 is controlled by control unit 110 to transmit and receive information to and from other computers. In the present embodiment, comic image formation device 100 may optionally include communication unit 160.

Comic image formation device 100 is implemented by computer hardware shown in FIG. 1 and software executed by control unit 110. Generally, such software is distributed in a manner stored in recording medium 151, read from recording medium 151 by medium drive device 154, and once stored in HDD 152. In addition, the software is read into RAM 122 and executed by control unit 110 described above. The hardware itself of the computer described above is common. Therefore, the most essential part of the present invention resides in the software recorded on recording medium 151. As the operation of the computer itself has been well known, detailed description in addition to the above will not be repeated here.

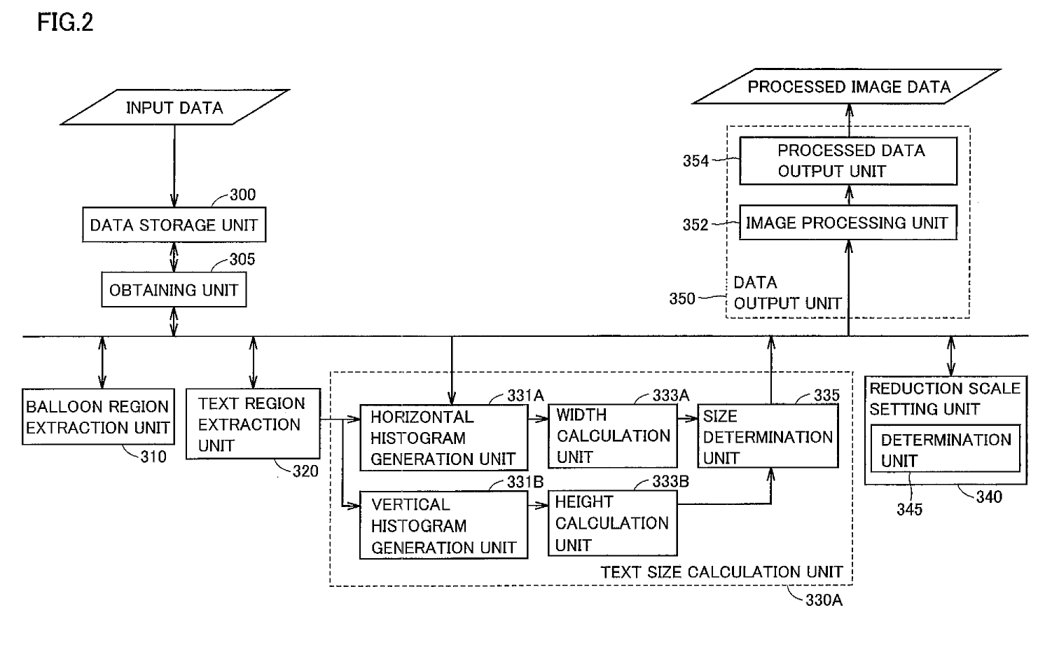

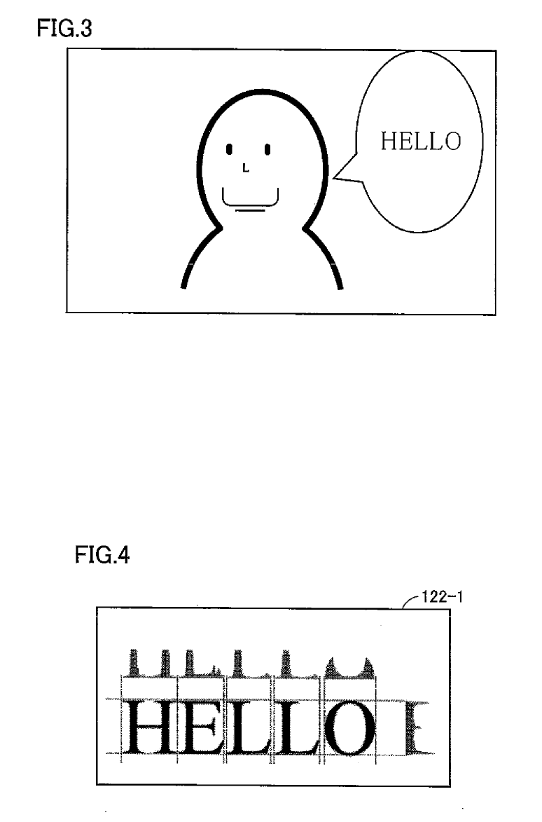

FIG. 2 is a functional block diagram of comic image formation device 100. FIG. 3 shows an exemplary comic strip stored in a data storage unit 300 as input image data. Referring to FIG. 2, comic image formation device 100 includes data storage unit 300, an obtaining unit 305, a balloon region extraction unit 310, a text region extraction unit 320, a text size calculation unit 330A, a reduction scale setting unit 340, and a data output unit 350.

Data storage unit 300 stores input image data read by medium drive device 154 or received by communication unit 160. Data storage unit 300 may store a designated scale (first reduction scale) and a text size threshold value (first size) input through input unit 130. Alternatively, data storage unit 300 may store in advance the designated scale and the text size threshold value. It is noted that the input image data as well as the designated scale and the text size threshold value are hereinafter collectively referred to as “input data”. In addition, an image of comic strips represented by the input image data is referred to as “comic image”.

Data storage unit 300 stores not only input data but also processed image data which will be described later, information on the comic image (third region), information on a balloon region (second region), and information on a text region (first region). In the present embodiment, the “processed image data” refers to image data output by data output unit 350. The information on the comic image includes a position of a boundary of the comic image (each frame or entire page), image data of a differently-colored image (binary image data), and the like. The information on the balloon region includes a position of a boundary of the balloon region, image data of a differently-colored image (binary image data), and the like. In the present embodiment, the differently-colored image refers to an image obtained by reducing an image of the balloon region and differently setting the color of pixels depending on whether a pixel is located inside the balloon or not. In addition, the information on the text region includes a position of a boundary of the text region, the number of characters in the image of the text region, a size of the character (text size), and the like. It is noted that the position refers, for example, to positional information expressed by a coordinate value or the like.

Obtaining unit 305 obtains the input image data representing a two-dimensional image and the designated scale. More specifically, for example, obtaining unit 305 receives the input image data from the outside of comic image formation device 100, such as a network, through communication unit 160. Alternatively, obtaining unit 305 reads the input image data from a storage medium or the like.

Then, obtaining unit 305 receives the designated scale from the outside of comic image formation device 100, such as a network, through communication unit 160. Alternatively, obtaining unit 305 reads the designated scale from a storage medium or the like. Alternatively, obtaining unit 305 accepts the designated scale from the user through input unit 130 or the like. For example, obtaining unit 305 may directly accept the designated scale from the user through input unit 130 or the like, or accept an instruction indicating “large size”, “medium size”, “small size”, or the like. Here, obtaining unit 305 may obtain the designated scale of 50% based on the instruction indicating “large size”, obtain the designated scale of 33% based on the instruction indicating “medium size”, and obtain the designated scale of 25% based on the instruction indicating “small size”.

Alternatively, obtaining unit 305 calculates the designated scale based on an image size of the input image data and an image size of display 142. For example, obtaining unit 305 may obtain the number of vertical and horizontal pixels of the input image data (input image size), obtain the number of vertical and horizontal pixels of display 142 (output image size), and obtain the designated scale by dividing the output image size by the input image size.

Balloon region extraction unit 310 (first extraction unit) extracts all graphics represented by the input image data to specify a region circumscribing each of graphics (that is, a region including only graphic), and causes data storage unit 300 to store the position indicating the boundary of that region. In the present embodiment, the region including only the graphic refers to the “balloon region”.

It is noted that balloon region extraction unit 310 may extract a region (comic image) including graphics such as a cartoon and characters such as lines, that is, a region surrounded by each frame or regions surrounded by all frames included in a page, based on the input image data.

For example, the position indicating the boundary between the balloon region and other regions or the position where the balloon region is present per se can be specified by using the following information.

(1) Any one point indicating the boundary between the balloon region and other regions, and the differently-colored image data representing the balloon region

(2) All positions indicating the boundary of the balloon region

(3) Position of one vertex of a rectangle circumscribing the balloon region, a width and a height of the rectangle, and the differently-colored image representing the balloon region

(4) Differently-colored image representing the balloon region, with an image as large as the comic image serving as the background

As the specific processing for extracting the balloon region represented by the input image data is well known, detailed description thereof will not be repeated.

Text region extraction unit 320 extracts the text region described below. The text region includes characters included in the balloon region stored in data storage unit 300. The boundary of the text region circumscribes the character included in the balloon region. For simplification of calculation of the size or the like, the text region extracted by text region extraction unit 320 preferably has a rectangular shape.

In the present embodiment, one text region includes all characters included in one balloon region. Specifically, text region extraction unit 320 detects the position of the boundary of the text region. When the position of the boundary of the text region is extracted, text region extraction unit 320 causes data storage unit 300 to store the position of the boundary of the text region in association with the position of the boundary of the balloon region including the text region.

For example, the position indicating the boundary between the text region and others or the position where the text region is present per se can be specified by using the following information. Here, an example where the text region is in a rectangular shape will be described, however, if the text region is not in a rectangular shape, the method the same as in the case of the balloon region is applicable.

(1) Position of any one point indicating the boundary (on a side of a rectangle) between the text region and others, and the image of the text region

(2) Position of any one point indicating the boundary (on a side of the rectangle) of the text region, and the differently-colored image representing the text region (differently-colored image representing the text region and the balloon region)

(3) Image representing only the text region, with an image as large as the comic image serving as the background

As the specific processing for extracting the text region is well known, detailed description thereof will not be repeated here.

Text size calculation unit 330A calculates the text size based on the position of the boundary of each text region stored in data storage unit 300 and the input image data. In the present embodiment, the “text size” represents the size of the character included in the text region.

Text size calculation unit 330A includes a horizontal histogram generation unit 331A, a vertical histogram generation unit 331B, a width calculation unit 333A, a height calculation unit 333B, and a size determination unit 335.

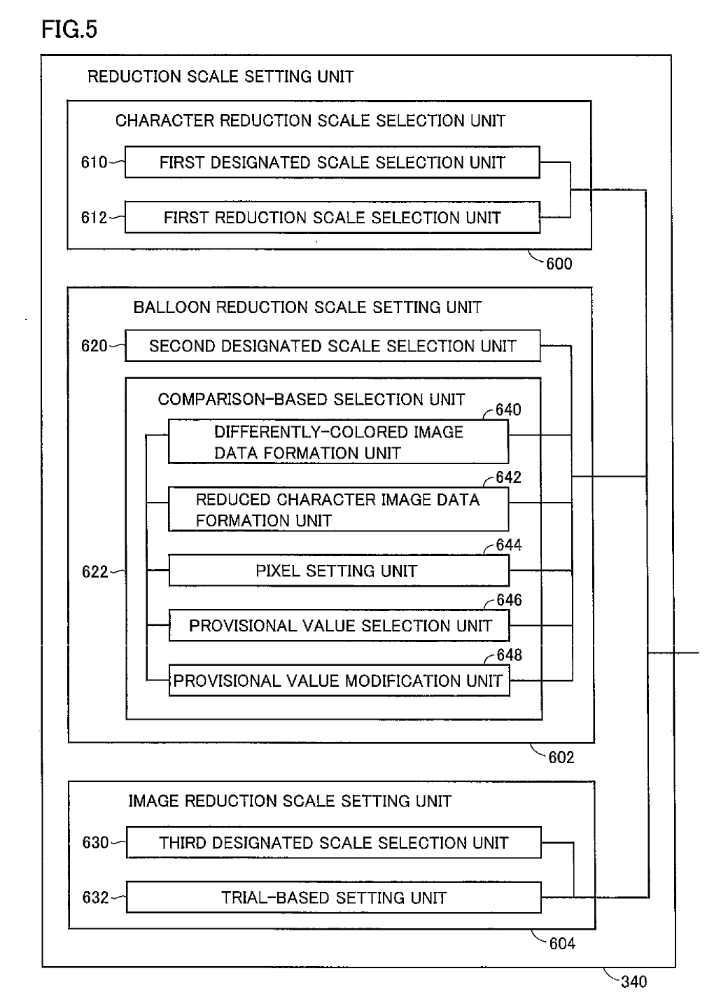

FIG. 4 is a conceptual diagram showing a histogram generated based on the image of the text region. As shown in FIGS. 2 to 4, horizontal histogram generation unit 331A generates a horizontal histogram showing color distribution in a horizontal direction of the image of the text region, by receiving the image of the text region as the input and showing the text image in monochrome (white component 0, black component 255).

Based on the horizontal histogram, width calculation unit 333A calculates a width of one character by determining as one character, a range extending from a position where transition from a low value to a high value is made to a position where transition from a high value to a low value is made,

Vertical histogram generation unit 331B generates a vertical histogram showing color distribution in a vertical direction of the image of the text region, by receiving the image of the text region as the input and showing the text image in monochrome (white component 0, black component 255). It is noted that information 122-1 representing the horizontal histogram and the vertical histogram is temporarily stored in data storage unit 300.

Based on the vertical histogram, height calculation unit 333B calculates a height of one character by determining as one character, a range extending from a position where transition from a low value to a high value is made to a position where transition from a high value to a low value is made.

Size determination unit 335 determines a size per one character based on me calculated width and height of one character. For example, an average value of widths and heights of all characters is determined as the size per one character. Text size calculation unit 330A does not necessarily have to calculate both of the width and the height, and it may calculate the size per one character by calculating any one of these.

In particular, if the horizontal histogram or the vertical histogram is not uniform, the following text size calculation method is effective. Specifically, if the widths of characters calculated based on the horizontal histogram are not uniform, the text size is effectively determined based on the vertical histogram (the height of each character). In contrast, if the heights of characters calculated based on the vertical histogram are not uniform, the text size is effectively determined based on the horizontal histogram (the width of each character).

More specifically, for example, when alphabets are written in the text region or when characters in proportional font are written in the text region, the method of calculating the text size based on the horizontal histogram may not be effective. In addition, when Japanese characters or characters in other languages are written horizontally or when characters in other fonts are written as well, the method of calculating the text size based on the horizontal histogram may not be effective. Thus, when the method of calculating the text size based on the horizontal histogram is not effective, the method of calculating the text size based only on the vertical histogram is effective.

Thus, when the horizontal histogram (the width of characters) is not uniform, the vertical histogram for one row may initially be generated and then the height of the character in that row may be calculated. Thereafter, by generating the vertical histogram for other rows and calculating the height of the character in each row, the text size may be determined based on the height thereof In contrast, when the vertical histogram (the height of characters) is not uniform, the horizontal histogram for one column may initially be generated and then the width of the character in that column may be calculated. Thereafter, by generating the horizontal histogram for other columns and calculating the width of the character in each column, the text size may be determined based on the width thereof.

Whether the characters are written in the text region vertically or horizontally can be determined based on the vertical histogram and the horizontal histogram. For example, when the vertical histogram is more uniform than the horizontal histogram (distribution is narrower), it can be determined that the characters are written in the horizontal direction. When the horizontal histogram is more uniform than the vertical histogram, it can be determined that the characters are written in the vertical direction. By generating again the histogram for each row after the determination, the text size can automatically be calculated.

Referring back to FIG. 2, reduction scale setting unit 340 calculates a text region reduction scale RTn representing a reduction scale of each text region, a balloon region reduction scale RFn representing a reduction scale of each balloon region, and a comic image reduction scale representing a reduction scale of a comic image.

Reduction scale setting unit 340 includes a determination unit 345 determining whether a size of the character reduced at a first reduction scale is equal to or greater than a first size. Determination unit 345 according to the present embodiment determines whether a value obtained by multiplying the text size calculated by text size calculation unit 330A by the designated scale (first reduction scale) exceeds the text size threshold value (first size) or not.

FIG. 5 is a functional block diagram of reduction scale setting unit 340 according to the present embodiment. Referring to FIG. 5, reduction scale setting unit 340 according to the present embodiment includes a character reduction scale selection unit 600, a balloon reduction scale setting unit 602, and an image reduction scale setting unit 604.

Character reduction scale selection unit 600 selects text region reduction scale RTn based on whether a value obtained by multiplying the text size calculated by text size calculation unit 330A by the designated scale exceeds the text size threshold value or not. Balloon reduction scale setting unit 602 sets balloon region reduction scale RFn in accordance with whether the designated scale is equal to text region reduction scale RTn or not. Image reduction scale setting unit 604 sets the comic image reduction scale in accordance with whether the designated scale is equal to balloon region reduction scale RFn or not.

Character reduction scale selection unit 600 includes a first designated scale selection unit 610 and a first reduction scale selection unit 612.

First designated scale selection unit 610 selects the designated scale as text region reduction scale RTn when a value obtained by multiplying the text size calculated by text size calculation unit 330A by the designated scale exceeds the text size threshold value. First reduction scale selection unit 612 selects as text region reduction scale RTn (second reduction scale), a value obtained by dividing the text size threshold value by the text size calculated by text size calculation unit 330A when a value obtained by multiplying the text size calculated by text size calculation unit 330A by the designated scale is equal to or smaller than the text size threshold value.

Balloon reduction scale setting unit 602 includes a second designated scale selection unit 620 and a comparison-based selection unit 622.

Second designated scale selection unit 620 selects the designated scale as balloon region reduction scale RFn when text region reduction scale RTn is equal to the designated scale. When text region reduction scale RTn is different from the designated scale, comparison-based selection unit 622 selects balloon region reduction scale RFn based on a result of comparison of the image generated from the input image data.

Comparison-based selection unit 622 includes a differently-colored image data formation unit 640, a reduced character image data formation unit 642, a pixel setting unit 644, a provisional value selection unit 646, and a provisional value modification unit 648.

Differently-colored image data formation unit 640 forms image data representing a differently-colored image. The image data representing the differently-colored image is formed by reducing the image of the balloon region at a provisional value of the reduction scale and setting a color of pixels constituting the image of the balloon region to a color in accordance with whether a pixel is located inside the balloon or not. Here, a frame itself representing the balloon region may be regarded as the inside of the balloon, or the frame itself representing the balloon region may be regarded as the outside of the balloon. Alternatively, a centerline of the frame may be regarded as the boundary between the inside and the outside. In the present embodiment, the frame itself is regarded as the outside of the balloon.

Reduced character image data formation unit 642 forms reduced character image data based on the input image data. The reduced character image data represents a reduced character image. The reduced character image is an image obtained by reducing the image of the text region at text region reduction scale RTn.

Pixel setting unit 644 sets the color of a pixel at a text region point in the differently-colored image to the color of the inside of the differently-colored image or to the color of the outside thereof The text region point is determined in advance in the text region. The number of text region points is not limited to 1. For example, each point forming the boundary of the text region may be adopted as the text region point. In the present embodiment, vertices at four corners of the text region are assumed as the text region point. Alternatively, the text region point may designate the character itself. Whether the boundary of the text region is located inside the differently-colored image or not can be determined based on the pixel at the text region point, depending on a position of the text region point relative to the differently-colored image and the color of the differently-colored image.

Provisional value selection unit 646 selects a value of balloon region reduction scale RFn. The selected value serves as the provisional value of the reduction scale. Namely, provisional value selection unit 646 sets balloon region reduction scale RFn such that it is equal to the provisional value of the reduction scale. Here, balloon region reduction scale RFn is set as such only when the color set by pixel setting unit 644, that is, the color of the text region point, is the same as the color of the pixel inside the balloon. In the present embodiment, it is assumed that balloon region reduction scale RFn is set as such when the color of all text region points is the same as the color of the pixels inside the balloon. Unlike the present embodiment, in an example where all points forming the boundary of the text region serve as the text region point, if the color of all these points is the same as the color of the pixels inside the balloon, balloon region reduction scale RFn should be set equal to the provisional value of the reduction scale.

Thus, a part of the balloon can be prevented from entering the text region. If there are two or more text region points, balloon region reduction scale RFn may naturally be set as described above on the condition that the color of a part of the text region points is the same as the color of the pixels inside the balloon.

Provisional value modification unit 648 modifies the provisional value of the reduction scale when the color set by pixel setting unit 644 is the same as the color of the pixels outside the balloon, that is, when the color of the text region point is the same as the color of the pixels outside the balloon. In the present embodiment, the provisional value of the reduction scale is modified when the color of at least one of the text region points is the same as the color of the pixels outside the balloon. Unlike the present embodiment, in an example where each point forming the boundary of the text region serves as the text region point, the provisional value of the reduction scale should be modified when the color of at least one of these points is the same as the color of pixels outside the balloon. If there are two or more text region points, the provisional value of the reduction scale may naturally be modified on the condition that the color of a part of the text region points is the same as the color of the pixels outside the balloon.

Image reduction scale setting unit 604 includes a third designated scale selection unit 630 and a trial-based setting unit 632.

Third designated scale selection unit 630 selects the designated scale as the comic image reduction scale when balloon region reduction scale RFn is equal to the designated scale. When balloon region reduction scale RFn is different from the designated scale, trial-based setting unit 532 sets the comic image reduction scale in accordance with the result of change in arrangement of the balloon region and the text region.

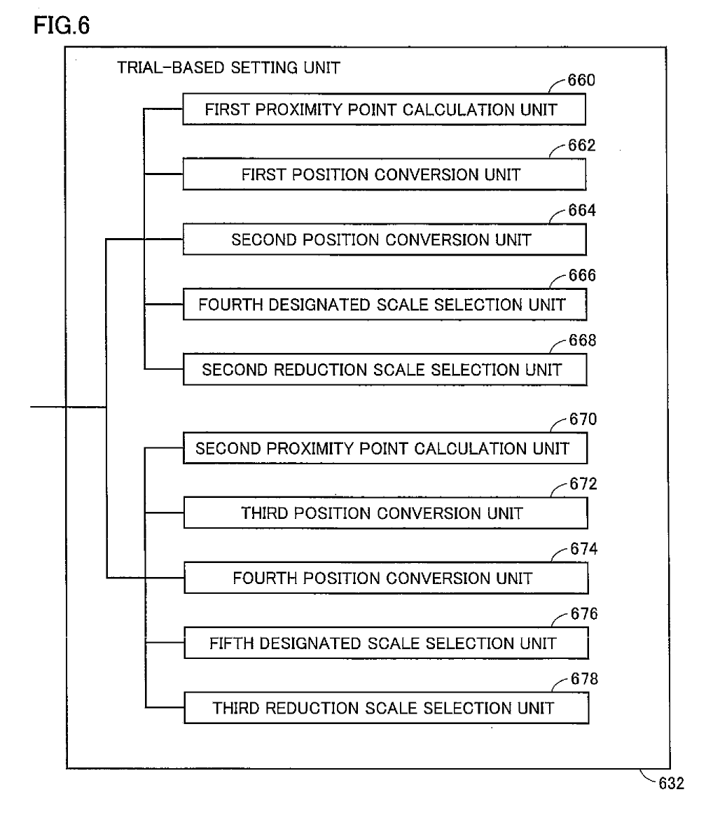

FIG. 6 is a functional block diagram of trial-based setting unit 632 according to the present embodiment. Referring to FIG. 6, trial-based setting unit 632 includes a first proximity point calculation unit 660, a first position conversion unit 662, a second position conversion unit 664, a fourth designated scale selection unit 666, a second reduction scale selection unit 668, a second proximity point calculation unit 670, a third position conversion unit 672, a fourth position conversion unit 674, a fifth designated scale selection unit 676, and a third reduction scale selection unit 678.

First proximity point calculation unit 660 calculates a position of a proximity point closest to a center of the comic image in the boundary of the balloon region, based on the position of the boundary of the balloon region and the position of the center of the comic image. Here, first proximity point calculation unit 660 may calculate a point closest to a central point of the comic image from among intersections of diagonal lines of the comic image and four sides of the balloon region, may calculate a point closest to a lower left vertex of the comic image from among intersections of diagonal lines of the comic image and four sides of the balloon region, or may calculate a point closest to the lower left vertex of the comic image in the four sides of the balloon region. In the present embodiment, description below will be given assuming that the proximity point is the point closest to the center of the comic image in the boundary of the balloon region.

A method for calculating the proximity point is not particularly limited. For example, first proximity point calculation unit 660 may calculate a distance from the center of the comic image for each point on the boundary of the balloon region, and the point corresponding to the smallest calculated distance may be employed as the proximity point.

First position conversion unit 662 calculates the position of the proximity point in reducing the comic image at the designated scale, by multiplying the position of the proximity point by the designated scale.

Second position conversion unit 664 calculates the position of the boundary of the balloon region. The position refers to a position that is obtained when the comic image reduced at the designated scale is synthesized with the image of the balloon region reduced at balloon region reduction scale RFn such that the proximity points match with each other. The position is calculated based on the position of the boundary of the balloon region, balloon region reduction scale RFn, and the position of the proximity point.

Fourth designated scale selection unit 666 selects the designated scale as the comic image reduction scale in the following case. That is, the case is such that the boundary of the balloon region is located within the comic image reduced at the designated scale when the comic image reduced at the designated scale is synthesized with the image of the balloon region reduced at balloon region reduction scale RFn.

Second reduction scale selection unit 668 calculates the comic image reduction scale when the following requirement is satisfied The requirement is such that the boundary of the balloon region is located outside the comic image reduced at the designated scale when the comic image reduced at the designated scale is synthesized with the image of the balloon region reduced at balloon region reduction scale RFn. When this requirement is satisfied, the comic image reduction scale is calculated based on the position of the boundary of the balloon region that is obtained when the comic image reduced at the designated scale is synthesized with the image of the balloon region reduced at balloon region reduction scale RFn.

Second proximity point calculation unit 670 calculates a position of a proximity point closest to the center of the comic image in the boundary of the text region, based on the position of the boundary of the text region and the position of the center of the comic image. A method for doing so is not particularly limited, as in the case of first proximity point calculation unit 660. For example, second proximity point calculation unit 670 may calculate a point closest to the central point of the comic image from among intersections of diagonal lines of the comic image and four sides of the text region, may calculate a point closest to a lower left vertex of the comic image from among intersections of diagonal lines of the comic image and four sides of the text region, or may calculate a point closest to the lower left vertex of the comic image in the four sides of the text region. In the present embodiment, description below will be given assuming that the proximity point is the point closest to the center of the comic image in the boundary of the text region.

Third position conversion unit 672 calculates the position of the proximity point in reducing the comic image at the designated scale, by multiplying the position of the proximity point by the designated scale.

Fourth position conversion unit 674 calculates the position of the boundary of the text region. The position refers to a position that is obtained when the comic image reduced at the designated scale is synthesized with the image of the text region reduced at text region reduction scale RTn such that the proximity points match with each other. The position is calculated based on the position of the boundary of the text region, text region reduction scale RTn, and the position of the proximity point.

Fifth designated scale selection unit 676 selects the designated scale as the comic image reduction scale in the following case. That is, the case is such that the boundary of the text region is located within the comic image reduced at the designated scale when the comic image reduced at the designated scale is synthesized with the image of the text region reduced at text region reduction scale RTn.

Third reduction scale selection unit 678 calculates the comic image reduction scale when the following requirement is satisfied. The requirement is such that the boundary of the text region is located outside the comic image reduced at the designated scale when the comic image reduced at the designated scale is synthesized with the image of the text region reduced at text region reduction scale RTn. When this requirement is satisfied, the comic image reduction scale is calculated based on the position of the boundary of the text region that is obtained when the comic image reduced at the designated scale is synthesized with the image of the text region reduced at text region reduction scale RTn.

Referring again to FIG. 2, data output unit 350 forms and outputs one image obtained by reducing the text region at each text region reduction scale RTn set by reduction scale setting unit 340, reducing each balloon region at each balloon region reduction scale RFn, reducing the comic image at the comic image reduction scale, and rearranging the resultants based on the relative position of the balloon region (hereinafter, this image is referred to as the “processed image”, the image data representing the processed image is the processed image data described above).

Alternatively, data output unit 3 50 may paste balloon image data obtained by reducing each balloon region at each balloon region reduction scale RFn on the comic image data obtained by reducing the comic image at the comic image reduction scale. Then, data output unit 350 may paste text image data obtained by reducing the text region at each text region reduction scale RTn on the comic image data on which the balloon image data has been pasted. Namely, data output unit 350 overwrites a portion corresponding to each balloon region in the comic image data obtained by reducing the comic image at the comic image reduction scale with the balloon image data. Then, data output unit 350 overwrites a portion corresponding to each text region in the comic image data overwritten with the balloon image data with the text image data.

It is noted that each text region reduction scale RTn refers, for example, to the designated scale (first reduction scale) or the second reduction scale. In addition, the comic reduction scale refers, for example, to the designated scale, or such a third reduction scale that the text region reduced at the second reduction scale remains inside the comic image as will be described later.

Data output unit 350 includes an image processing unit 352 and a processed image data output unit 354. Image processing unit 352 forms (creates) processed image data from the input image data. Processed image data output unit 354 outputs the processed image data, for example, by displaying the image.

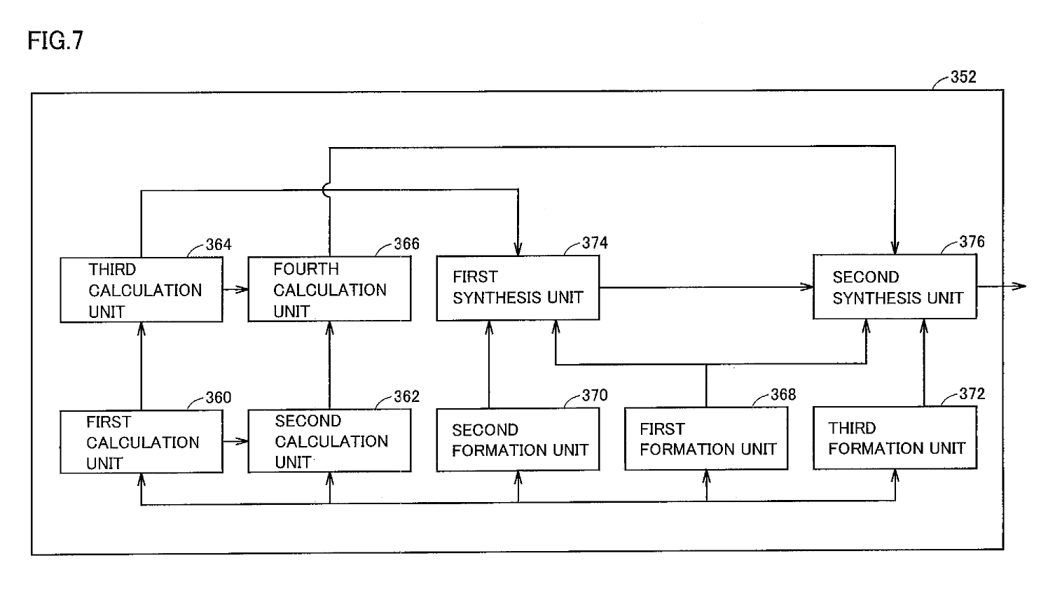

FIG. 7 is a functional block diagram of image processing unit 352 according to the present embodiment. Referring to FIG. 7, image processing unit 3 52 according to the present embodiment includes a first calculation unit 3 60, a second calculation unit 362, a third calculation unit 364, a fourth calculation unit 366, a first formation unit 368, a second formation unit 370, a third formation unit 372, a first synthesis unit 374, and a second synthesis unit 376.

First calculation unit 360 calculates a position of a balloon region point based on the position of the boundary of the balloon region. In the present embodiment, the balloon region point refers to the point proximate to the center of the comic image.

Second calculation unit 362 calculates a position of a text region point relative to the balloon region point based on the position of the boundary of the text region and the position of the balloon region point. In the present embodiment, the text region point refers to vertices of four corners of the text region.

Third calculation unit 364 calculates the position of the balloon region point in the image represented by the processed image data, by multiplying the position of the balloon region point by a comic image reduction scale RiM.

Fourth calculation unit 366 calculates the position of the text region point in the image represented by the processed image data. The position of the text region point in the image represented by the processed image data is calculated by multiplying the position of the text region point relative to the balloon region point by balloon region reduction scale RFn, multiplying the value of the position of the balloon region point in the image represented by the processed image data by comic image reduction scale RiM, and adding resultant values together.

First formation unit 368 forms reduced image data. The reduced image data represents a reduced image obtained by reducing the comic image at comic image reduction scale RiM.

Second formation unit 370 forms reduced graphic data. The reduced graphic data represents a reduced graphic image obtained by reducing the image of the balloon region at balloon region reduction scale REn.

Third formation unit 372 forms reduced character image data. The reduced character image data represents a reduced character image obtained by reducing the image of the text region at text region reduction scale RTn.

First synthesis unit 374 synthesizes the reduced image and the reduced graphic image by using the reduced image data and the reduced graphic data such that the balloon region point in the reduced image described above and the balloon region point in the reduced graphic image described above match with each other. The balloon region point is calculated when the reduced graphic image data is formed in a sixth procedure which will be described later. Synthesis is performed by modifying a part of the reduced image data so as to match with the content of the reduced graphic data. Which data is to be modified is determined based on the balloon region point.

Second synthesis unit 376 synthesizes the reduced image and the reduced character image by using the reduced image data and the reduced character image data such that the text region point in the reduced image described above and the text region point in the reduced character image described above match with each other. The text region point is calculated when the reduced character image data is formed in a seventh procedure which will be described later. Synthesis here is again performed as in synthesis by first synthesis unit 374.

Here, text region reduction scale RTn, balloon region reduction scale RFn, and the comic image reduction scale indicate a ratio of a size of a reduced image to a size of an image before reduction. One hundred percent is assumed to indicate the same size, however, 100% may not necessarily indicate the same size so long as a ratio of a size of a reduced image to a size of an image before reduction is indicated.

In addition, the designated scale and the text size threshold value included in the input data in the description above do not have to be input directly through input unit 130. For example, they may be numeric values extracted from a continuous message generated in a flow of operations through CUI (Graphical User Interface) or may be numeric values extracted based on a selection operation from among sizes defined stepwise.

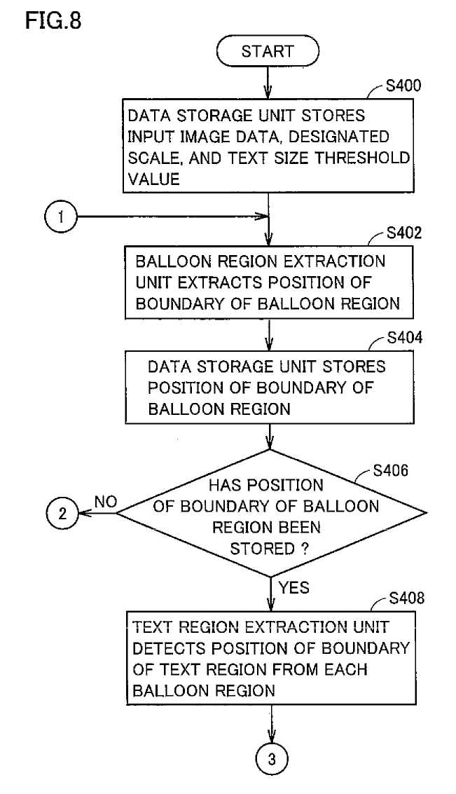

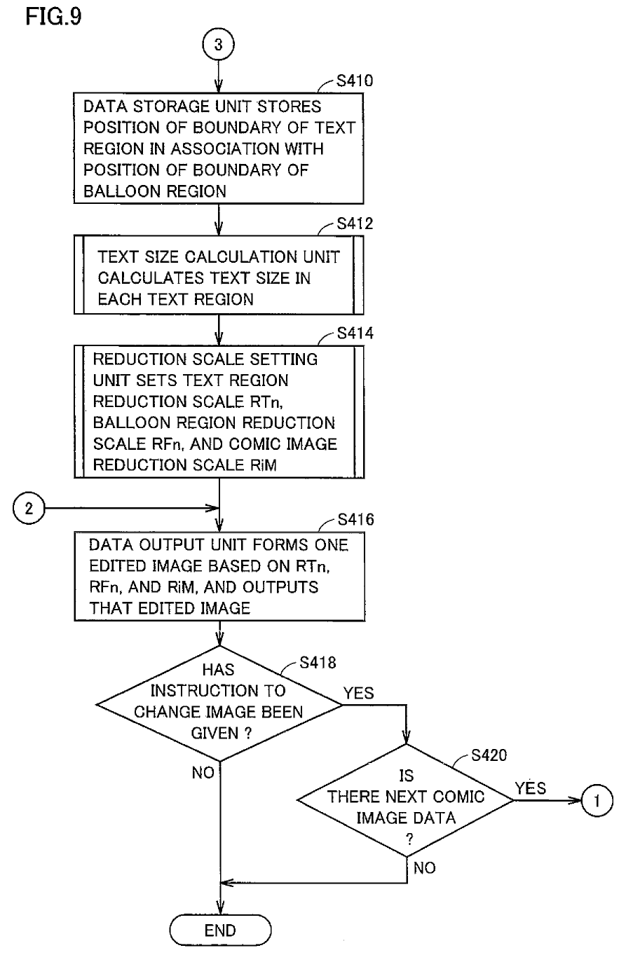

Referring to FIGS. 8 and 9, the program executed in comic image formation device 100 carries out the following control in connection with formation of the processed image data. In the following, the position of each region can be determined in terms of a two-dimensional position, assuming that the central point of the input comic image serves as the origin, a direction from the origin to the right of the image is a positive direction of x axis, and an upward direction in the image is a positive direction of y axis.

In step S400, data storage unit 300 stores the comic image data, the designated scale, and the text size threshold value.

In step S402, balloon region extraction unit 310 extracts the position of the boundary of the balloon region. The balloon region to be extracted is a region including graphics. Balloon region extraction unit 310 may automatically extract the balloon region. As the specific method for extracting the position of the boundary of the graphic or the region occupied by the graphic is well known, detailed description thereof will not be repeated here.

Alternatively, balloon region extraction unit 310 may extract the balloon region based on the user's operation of input unit 130 to designate the graphic. Output unit 140 displays in advance the comic image. The user can thus designate the graphic in the comic image. Balloon region extraction unit 310 detects the graphic designated by the user and extracts the position of the boundary of the region circumscribing the graphic. In the present embodiment, balloon region extraction unit 310 regards the graphic designated by the user as the balloon and extracts the position of the boundary thereof. Whether the graphic is actually the balloon or not is not identified.

In step 8404, data storage unit 300 stores the position of the boundary of the balloon region.

Referring again to FIG. 8, in step S406, text region extraction unit 320 determines whether the position of the boundary of the balloon region has been stored in data storage unit 300 or not. When it is determined that the position of the boundary has been stored (YES in step S406), the process proceeds to step S408. Otherwise (NO in step S406), the process proceeds to step S416.

In step S408, text region extraction unit 320 detects the position of the boundary of the text region from each balloon region. As described above, in the present embodiment, the position of the boundary of the text region is automatically detected. As the specific processing for doing so is well known, detailed description thereof will not be repeated.

In step S410, text region extraction unit 320 causes data storage unit 300 to store the position of the boundary of the text region. Data storage unit 300 stores the position of the boundary of the text region in association with the position of the boundary of the balloon region including the text region.

In step S412, text size calculation unit 330A calculates the size of the character (text size) in each text region. Data storage unit 300 stores the text size calculated by text size calculation unit 330A in association with the position of the boundary of the text region used for calculating the text size.

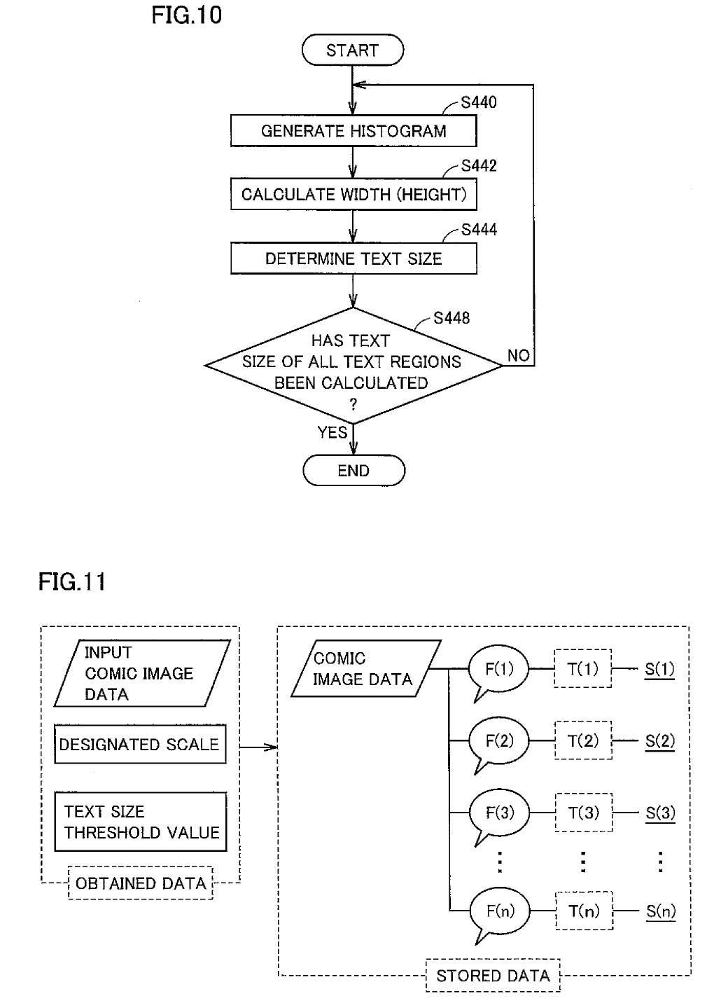

FIG. 10 is a flowchart showing a processing procedure for calculating the text size. As shown in FIG. 10, horizontal histogram generation unit 33 1A generates a horizontal histogram showing color distribution in a horizontal direction of the image of the text region, by receiving the image of the text region as the input and showing the text image in monochrome (white component 0, black component 255) (S440). Width calculation unit 333A calculates a width of one character by determining as one character, a range extending from a position where transition from a low value to a high value is made to a position where transition from a high value to a low value is made, based on the horizontal histogram (S442). Size determination unit 335 determines a size per one character based on the calculated width of one character (S444). For example, an average value of widths of all characters is determined as the size per one character. When text size calculation unit 330A calculates the text size of all text regions (YES in step S448), the processing for calculating the text size ends.

Alternatively, vertical histogram generation unit 331B generates a vertical histogram showing color distribution in a vertical direction of the image of the text region, by receiving the image of the text region as the input and showing the text image in monochrome (white component 0, black component 255) (step S440). Height calculation unit 333B calculates a height of one character by determining as one character, a range extending from a position where transition from a low value to a high value is made to a position where transition from a high value to a low value is made, based on the vertical histogram (step S442). Size determination unit 335 determines a size per one character based on the calculated height of one character (step S444). For example, an average value of heights of all characters is determined as the size per one character. When text size calculation unit 330A calculates the text size of all text regions (YES in step S448), the processing for calculating the text size ends.

FIG. 11 is a conceptual diagram showing that the positional information on the balloon region, the positional information on the text region, or the text size has been specified from the input data (obtained data) through the processing until this time point and stored in data storage unit 300. In FIG. 11, F(1), F(2), F(3), . . . , F(n) indicate the positional information on the balloon region, T(1), T(2), T(3), . . . , T(n) indicate the positional information on the text region, and S(1), S(2), S(3), . . . , S(n) indicate the text sizes.

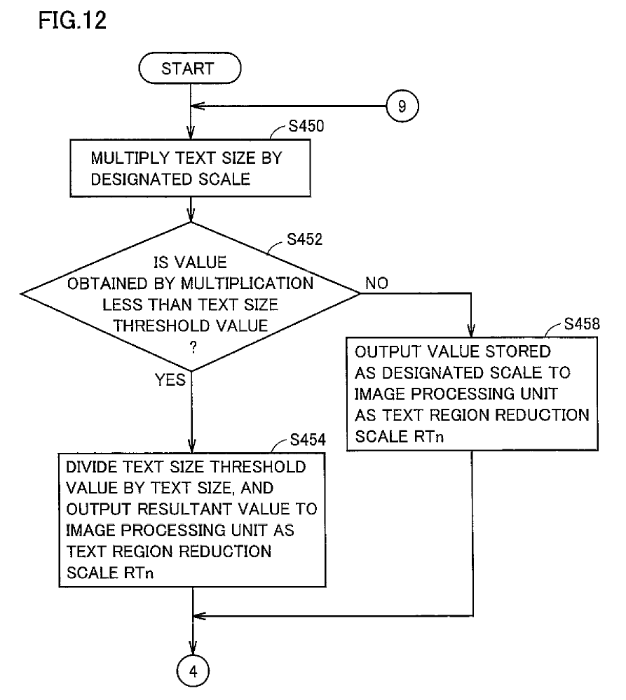

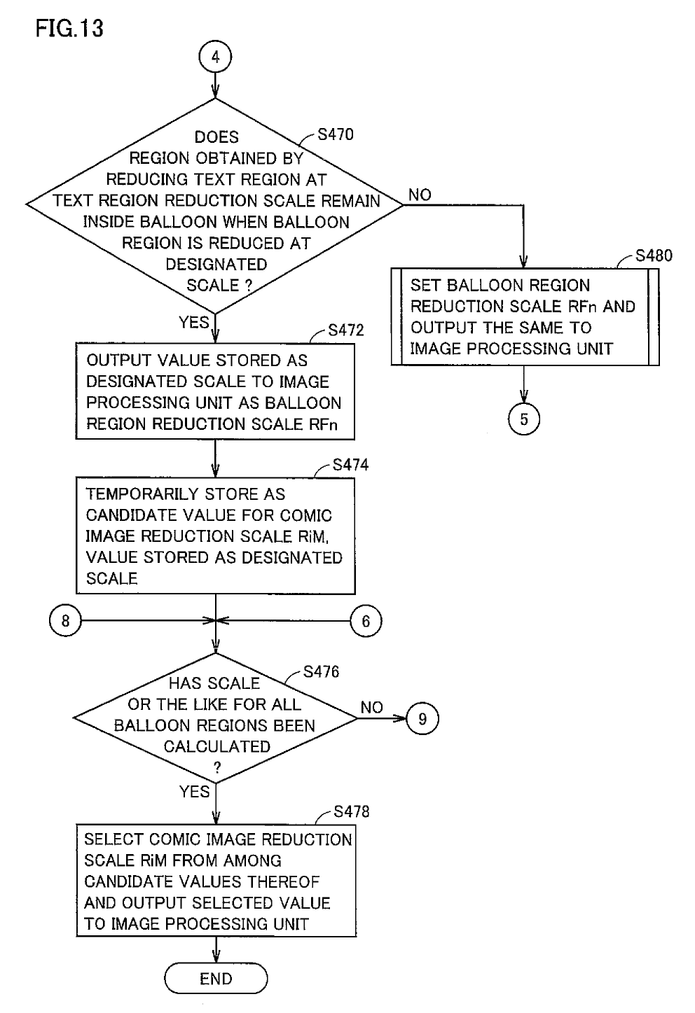

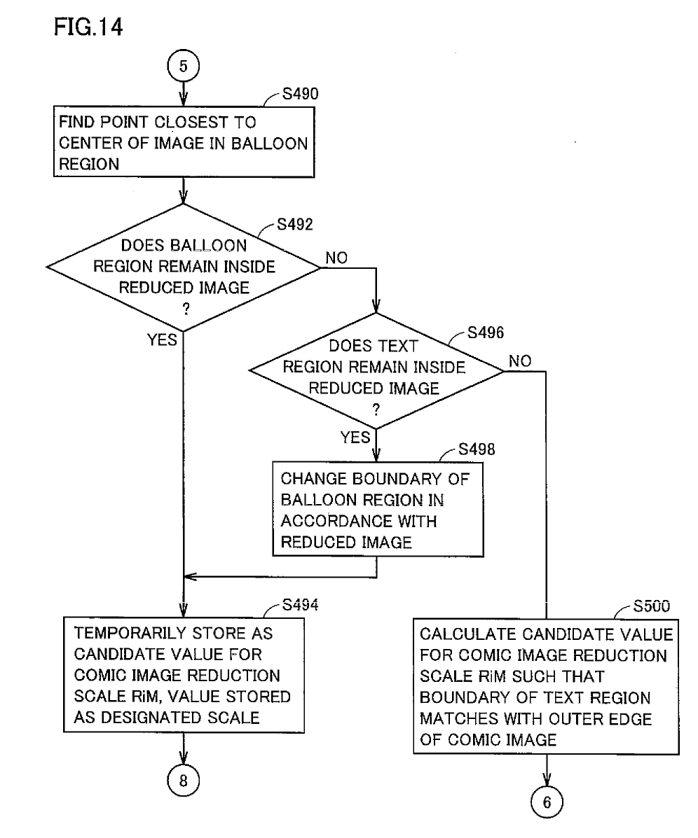

Referring again to FIG. 9, in step S414, reduction scale setting unit 340 sets text region reduction scale RTn, balloon region reduction scale RFn, and comic image reduction scale RiM. The specific processing for doing so is as shown in FIGS. 12 to 14.

In step S416, image processing unit 352 forms the processed image data based on text region reduction scale RTn, balloon region reduction scale RFn, and comic image reduction scale RiM. When the processed image data is formed, processed image data output unit 354 outputs the processed image data.

In the present embodiment, image processing unit 352 forms the processed image data in accordance with procedures below. The first procedure is such a procedure that first calculation unit 360 calculates the position of the balloon region point based on the position of the boundary of the balloon region. In the present embodiment, the balloon region point is the point proximate to the center of the comic image.

The second procedure is such a procedure that second calculation unit 362 calculates the position of the text region point relative to the balloon region point based on the position of the boundary of the text region and the position of the balloon region point. In the present embodiment, the text region point is the vertices of four corners of the text region.

The third procedure is such a procedure that third calculation unit 364 calculates the position of the balloon region point in the image represented by the processed image data by multiplying the position of the balloon region point by comic image reduction scale RiM.

The fourth procedure is such a procedure that fourth calculation unit 366 calculates the position of the text region point in the image represented by the processed image data. The position of the text region point in the image represented by the processed image data is calculated by multiplying the position of the text region point relative to the balloon region point by balloon region reduction scale RFn, multiplying the value of the position of the balloon region point in the image represented by the processed image data by comic image reduction scale RiM, and adding resultant values together.

The fifth procedure is such a procedure that first formation unit 368 forms the reduced image data. The reduced image data represents the reduced image obtained by reducing the comic image at comic image reduction scale RiM.

The sixth procedure is such a procedure that second formation unit 370 forms reduced graphic data. The reduced graphic data represents the reduced graphic image obtained by reducing the image of the balloon region at balloon region reduction scale RFn.

The seventh procedure is such a procedure that third formation unit 372 forms the reduced character image data. The reduced character image data represents the reduced character image obtained by reducing the image of the text region at text region reduction scale RTn.

The eighth procedure is such a procedure that first synthesis unit 374 synthesizes the reduced image and the reduced graphic image by using the reduced image data and the reduced graphic data such that the balloon region point in the reduced image in the fifth procedure and the balloon region point in the reduced graphic image in the sixth procedure match with each other. It is noted that the balloon region point is calculated when the reduced graphic image data is formed in the sixth procedure. Synthesis is performed by modifying a part of the reduced image data so as to match with the content of the reduced graphic data. Which data is to be modified is determined based on the balloon region point.

The ninth procedure is such a procedure that second synthesis unit 376 synthesizes the reduced image and the reduced character image by using the reduced image data and the reduced character image data such that the text region point in the reduced image in the fifth procedure and the text region point in the reduced character image in the seventh procedure match with each other. Synthesis is again performed as in synthesis in the eighth procedure. The text region point is calculated when the reduced character image data is formed in the seventh procedure.

In step S418, balloon region extraction unit 310 determines whether or not another processed image data is to be formed and output, based on a user's instruction accepted by input unit 130 (image change instruction). When it is determined that another processed image data is to be formed and output (YES in step S418), the process proceeds to step S420. Otherwise (NO in step S418), the process ends.

In step S420, balloon region extraction unit 310 determines whether or not there is input comic image data to be processed next in response to the user's instruction accepted in step S418. When it is determined that there is such input comic image data (YES in step S420), the process proceeds to step S402. Otherwise (NO in step S420), the process ends.

Referring to FIGS. 12 to 14, the program executed in comic image formation device 100 carries out the following control in setting the reduction scale.

In step S450, first designated scale selection unit 610 multiplies the text size stored in data storage unit 300 by the designated scale. The size of the character multiplied by the designated scale is the text size of the text region for which text region reduction scale RTn or the like has not yet been set. The order of selection of a text size of any text region is determined in advance.

In step S452, first designated scale selection unit 610 determines whether the value obtained as a result of multiplication in step S450 is smaller than the text size threshold value or not. When it is determined that the resultant value is smaller than the text size threshold value (YES in step S452), the process proceeds to step 8454. Otherwise (NO in step S452), the process proceeds to step S458.

In step S454, first reduction scale selection unit 612 divides the text size threshold value by the text size (before multiplication by the designated scale) and outputs the resultant value to image processing unit 352 as text region reduction scale RTn.

In step S458, first designated scale selection unit 610 outputs to image processing unit 352 as text region reduction scale RTn, the value stored in data storage unit 300 as the designated scale.

In step S470, second designated scale selection unit 620 determines where or not the text region reduced at text region reduction scale RTn remains inside the balloon when the text region is reduced at the designated scale, through the following five procedures.

The first procedure is a procedure for forming bit map data. With regard to this bit map data, the reduction scale for the balloon region is equal to the designated scale. In addition, the image represented by the bit map data is colored in two different colors with the balloon frame serving as the boundary. Such bit map data is formed by initially forming the bit map data of the image obtained by reducing the balloon region at the designated scale and changing the color of a pixel based on whether the pixel is located within the balloon or not. As described previously, the balloon frame itself may be regarded as the inside of the balloon, or the balloon frame itself may be regarded as the outside of the balloon. Alternatively, a centerline of the balloon frame may be regarded as the boundary between the inside and the outside. In the present embodiment, the balloon frame itself is regarded as the outside of the balloon region.

The second procedure is a procedure for calculating the position of the center of the text region in the balloon region reduced at the designated scale. The position is calculated by multiplying the position of the center of the text region relative to the balloon region point by the designated scale.

The third procedure is a procedure for calculating the position of the text region point relative to the center of the text region when the text region is reduced at text region reduction scale RTn.

The fourth procedure is a procedure for converting the position calculated in the third procedure into the position in the balloon region reduced at the designated scale.

The fifth procedure is a procedure for determining the color of the pixel at the position calculated in the fourth procedure, in the image represented by the bit map data formed in the first procedure. If the color of this pixel is the same as the color of the pixel inside the balloon, the region obtained by reducing the text region at text region reduction scale RTn remains inside the balloon region reduced at the designated scale.

Though the present embodiment is configured to move the relative position based on a ratio, for example, data output unit 350 may be controlled such that the text region remains inside the balloon region by dynamically moving the text region in up and down and left and right directions.

When it is determined that the reduced text region remains inside the balloon region (YES in step S470), the process proceeds to step S472. Otherwise (NO in step S470), the process proceeds to step S480.

In step S472, second designated scale selection unit 620 outputs the designated scale to image processing unit 352 as balloon region reduction scale RFn.

In step S474, data storage unit 300 temporarily stores the designated scale as the candidate value for comic image reduction scale RiM.

In step S476, second designated scale selection unit 620 determines whether the scale or the like of all balloon regions has been calculated or not. When it is determined that the scale or the like has been calculated (YES in step S476), the process proceeds to step S478. Otherwise (NO in step S476), the process proceeds to step S450.

In step S478, second designated scale selection unit 620 selects as comic image reduction scale RiM, a maximum value from among the candidate values temporarily stored in data storage unit 300, and outputs the selected value to image processing unit 352.

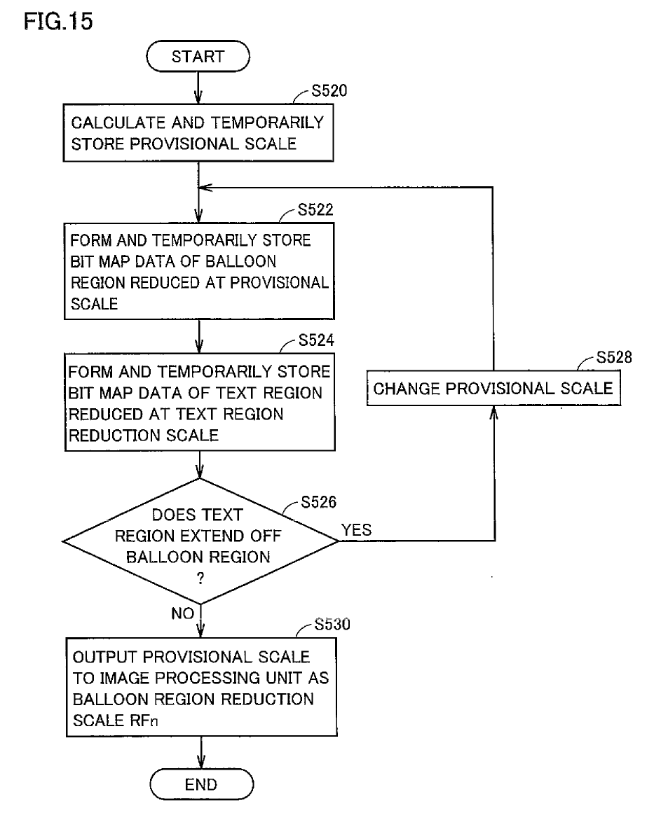

In step 8480, comparison-based selection unit 622 sets balloon region reduction scale RFn and outputs the same to image processing unit 352. Specifically, the processing is as shown in FIG. 15.

In step S490, first proximity point calculation unit 660 calculates the position of the point closest (proximity point) to the center of the comic image in the balloon region. In the present embodiment, the position is the position relative to the center of the comic image.

In step S492, first position conversion unit 662 calculates the position of the proximity point in reducing the comic image at the designated scale, by multiplying the position of the proximity point by the designated scale. After the position is calculated, second position conversion unit 664 calculates the position of the boundary of the balloon region relative to the proximity point when the image of the balloon region is reduced at balloon region reduction scale RFn. When the relative position is calculated, second position conversion unit 664 adds the relative position to the position calculated by first position conversion unit 662. Thus, the position of the boundary of the balloon region (the position relative to the center in the comic image reduced at the designated scale) when the comic image reduced at the designated scale is synthesized with the image of the balloon region reduced at balloon region reduction scale RFn such that the proximity points match with each other is calculated.

Based on the value of this position (that is, based on whether or not the value of this position exceeds the position of the outer perimeter of the comic image reduced at the designated scale), fourth designated scale selection unit 666 determines whether the balloon region remains inside the reduced comic image or not. When it is determined that the balloon region remains inside the reduced comic image (YES in step S492), the process proceeds to step S494. Otherwise (NO in step S492), the process proceeds to step S496.

In step S494, fourth designated scale selection unit 666 causes data storage unit 300 to temporarily store as the candidate value for comic image reduction scale RiM, the value stored as the designated scale.

In step S496, second proximity point calculation unit 670 calculates the position of the point closest (text proximity point) to the center of the comic image in the text region. In the present embodiment, the position is the position relative to the center of the comic image. When the position of the text proximity point is calculated, third position conversion unit 672 calculates the position of the text proximity point in reducing the comic image at the designated scale, by multiplying the position of the text proximity point by the designated scale. After the position is calculated, fourth position conversion unit 674 calculates the position of the boundary of the text region relative to the text proximity point when the image of the text region is reduced at text region reduction scale RTn. When the relative position is calculated, fourth position conversion unit 674 adds the relative position to the position calculated by third position conversion unit 672. Thus, the position of the boundary of the text region (the position relative to the center in the comic image reduced at the designated scale) when the comic image reduced at the designated scale is synthesized with the image of the text region reduced at text region reduction scale RTn such that the proximity points match with each other is calculated. Based on the value of this position (that is, based on whether or not the value of this position exceeds the position of the outer perimeter of the comic image reduced at the designated scale), fifth designated scale selection unit 676 determines whether the text region remains inside the reduced comic image. When it is determined that the text region remains inside the reduced comic image (YES in step S496), the process proceeds to step 8498. Otherwise (NO in step S496), the process proceeds to step S500.

The processing in step S498 will be described based on a coordinate system in which the central point of the comic image (frame) is defined as the origin. In the following, it is assumed that positions in step S498 and step S500 all take positive values and that a position of the balloon region point when the comic image has not been reduced is defined as (Fx, Fy). Then, the position of the balloon region point when the comic image is reduced at a designated scale n is expressed as (n×Fx, n×Fy). Here, the balloon region may be located in accordance with the balloon region point and a part of the balloon may be located outside the reduced comic image. On the other hand, the text region is located within the reduced comic image.

Then, data output unit 350 carries out correction for trimming the balloon region and leaving the text region. Namely, data output unit 350 cuts away a portion of the balloon region extending off the comic image at the boundary line (frame) of the reduced comic image and trims the balloon region extending off the comic image.

The processing in step S500 will be described based on a coordinate system in which the central point of the comic image is defined as the origin. The positional information on the text proximity point when the comic image has not been reduced is defined as (Tx, Ty). Here, the text proximity point is a point closest to the origin among the text region points. The positional information on the text proximity point when the comic image is reduced at designated scale n is expressed as (n×Tx, n×Ty). Here, the text region may be located in accordance with the text proximity point and a part of the text region may be located outside the reduced comic image.

Here, a width and a height of the text region reduced at text region reduction scale RTn are denoted as Tw and Th, respectively. In addition, a position of the vertex of the comic image located in a direction from the central point toward the text proximity point when the comic image is reduced at designated scale n is defined as (n×Mx, n×My). Here, the vertex of the comic image is the corner of each frame or the corner of each page.

Here, at least any of a state (1) that n×Tx+Tw exceeds n×Mx or a state (2) that n×Ty+Th exceeds n×My is satisfied. In order to correct such a relative position, n is decreased until the state (1) that n×Tx+Tw≦n×Mx and the state (2) that n×Ty+Th≦n×My are satisfied, which is in turn adopted as the comic image reduction scale.

Referring to FIG. 15, the program executed in comic image formation device 100 carries out the following control in setting balloon region reduction scale RFn.

In step S520, provisional value modification unit 648 calculates the provisional scale and causes data storage unit 300 to temporarily store the same. The provisional scale calculated in this step is a value obtained by multiplying the designated scale by a prescribed value. The provisional scale may naturally be a value obtained by subtracting a prescribed value from the designated scale (including subtraction of a natural number and addition of a negative value), however, in the present embodiment, it is a value obtained by multiplying the designated scale by a prescribed value. The “prescribed value” is determined in advance by a designer or the like of comic image formation device 100.

In step S522, differently-colored image data formation unit 640 forms bit map data representing the differently-colored image of the balloon region reduced at the provisional scale and causes data storage unit 300 to temporarily store the bit map data.

In step S524, reduced character image data formation unit 642 forms the reduced character image data and causes data storage unit 300 to temporarily store the same. In addition, reduced character image data formation unit 642 also forms bit map data of the image obtained by coloring the reduced character image in two different colors based on whether a pixel constitutes the character or not, and causes data storage unit 300 to temporarily store the same.

In step S526, pixel setting unit 644 determines whether the text region extends off the balloon region or not, based on the bit map data of the balloon region temporarily stored in data storage unit 300. When it is determined that the text region extends off the balloon region (YES in step S526), the process proceeds to step S528. Otherwise (NO in step S526), the process proceeds to step S530.

In step S528, provisional value modification unit 648 modifies the provisional scale stored in data storage unit 300. The resultant provisional scale is a value obtained by multiplying the provisional scale stored in data storage unit 300 in step S526 by the value used for calculating the provisional scale in step S520. This value is calculated by provisional value modification unit 648.

In step S530, provisional value selection unit 646 outputs the provisional scale temporarily stored in data storage unit 300 to image processing unit 352 as balloon region reduction scale RFn.

An operation of the comic image formation device based on the structure and the flowchart as above will be described.

[Example where Lines are Written Around the Center of the Balloon]

Data storage unit 300 stores the comic image data, the designated scale, and the text size threshold value (step S400). Here, it is assumed that the comic image data representing the comic image shown in FIG. 3 is stored.

When the comic image data or the like is stored, balloon region extraction unit 310 extracts the position of the boundary of the balloon region (step S402). When the position is extracted, data storage unit 300 stores the position of the boundary of the balloon region (step S404).

When the position of the boundary is stored, text region extraction unit 320 determines whether the position of the boundary of the balloon region has been stored in data storage unit 300 or not (step S406). Here, as the position has been stored (YES in step S406), text region extraction unit 320 detects the position of the boundary of the text region from the balloon region (step S408). When the position of the boundary of the text region is detected, data storage unit 300 stores the position of the boundary of the text region in association with the position of the boundary of the balloon region (step S410).

When the position of the boundary of the text region is stored, horizontal histogram generation unit 331A generates a horizontal histogram showing color distribution in a horizontal direction of the image of the text region, by receiving the image of the text region as the input and showing the text image in monochrome (white component 0, black component 255) (S440). Width calculation unit 333A calculates a width of one character by determining as one character, a range extending from a position where transition from a low value to a high value is made to a position where transition from a high value to a low value is made, based on the horizontal histogram (S442). Size determination unit 335 determines a size per one character based on the calculated width of one character (step S444). For example, an average value of widths of all characters is determined as the size per one character. Text size calculation unit 330A determines whether the text size of all text regions has been calculated or not (step S448).

As can clearly be seen from FIG. 3, in the present embodiment, as the single text region was extracted (YES in step S448), first designated scale selection unit 610 multiplies the size of the character by the designated scale (step S450). When the size of the character is multiplied by the designated scale, first designated scale selection unit 610 determines whether the value resulting from multiplication is smaller than a text size threshold value iT or not (step S452).

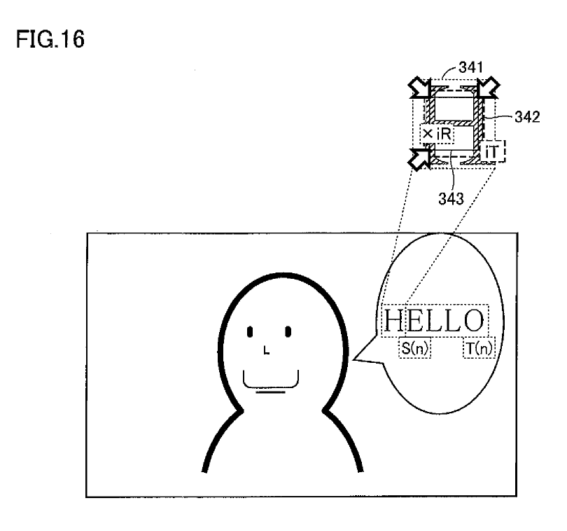

FIG. 16 is a conceptual diagram showing a determination method performed by reduction scale setting unit 340 in this step. This determination is shown, assuming the character arranged in the upper right of the text region as an example. A rectangle 341 shown with short dashed line around the character shown by way of example represents a region occupied by the character before reduction of the image. A rectangle 342 shown with long dashed line represents a region occupied by the character of a size corresponding to text size threshold value iT. A rectangle 343 shown with solid line represents a region occupied by the character reduced at a designated scale iR.

As can clearly be seen from FIG. 16, since the value resulting from multiplication in step S450 is smaller than the text size threshold value (YES in step S452), first reduction scale selection unit 612 divides the text size threshold value by the text size and outputs the resultant value to image processing unit 352 as text region reduction scale RTn (step S454).

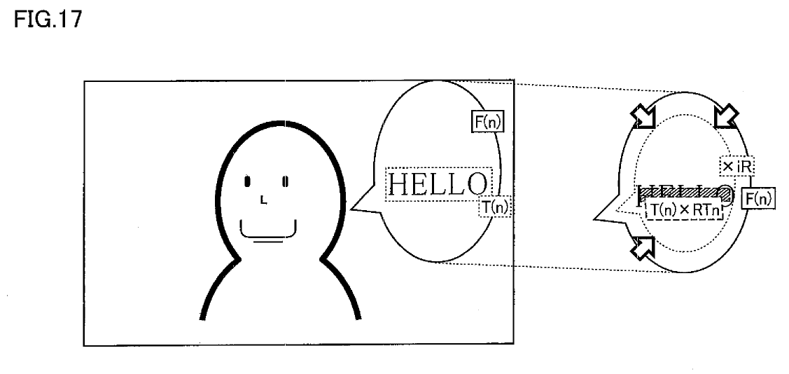

When multiplication is performed, second designated scale selection unit 620 determines whether or not the text region reduced at text region reduction scale RTn remains inside the balloon obtained when the balloon region is reduced at the designated scale (step S470). FIG. 17 is a conceptual diagram showing a determination method performed by second designated scale selection unit 620 here. FIG. 17 shows that a balloon indicated with three arrows is a balloon reduced at designated scale iR. A hatched rectangle represents the text region reduced at text region reduction scale RTn. Here, as it is determined that the reduced text region remains inside the balloon (YES in step S470), second designated scale selection unit 620 outputs designated scale iR to image processing unit 352 as balloon region reduction scale RFn (RFn=iR) (step S472).

When balloon region reduction scale RFn is output, data storage unit 300 temporarily stores the designated scale as the candidate value for comic image reduction scale RiM (step S474). When the candidate value is stored, second designated scale selection unit 620 determines whether the scale or the like of all balloon regions has been calculated or not (step S476). Here, as can clearly be seen from FIG. 3, since only a single balloon region was extracted (YES in step S476), second designated scale selection unit 620 selects comic image reduction scale RiM from among the candidate values stored in data storage unit 300 and outputs the same to image processing unit 352 (step S478).

When comic image reduction scale RiM is output, image processing unit 352 forms the processed image data based on text region reduction scale RTn, balloon region reduction scale RFn, and comic image reduction scale RiM. When the processed image data is formed, processed image data output unit 354 outputs the processed image represented by the processed image data (step S416).

When the processed image is output, balloon region extraction unit 310 determines whether an instruction to change the image to be displayed has been given or not (step S418). Here, as it is assumed that no such instruction has been given (NO in step S418), the process ends.

[Example where Lines are Written all Over the Balloon]

After the processing until step S454 (S458), second designated scale selection unit 620 determines whether the text region reduced at text region reduction scale RTn remains inside the balloon obtained when the balloon region is reduced at the designated scale (step S470). Here, as it is assumed that the reduced text region does not remain inside the balloon (NO in step S470), provisional value modification unit 648 calculates the provisional scale and causes data storage unit 300 to temporarily store the same (step S520).

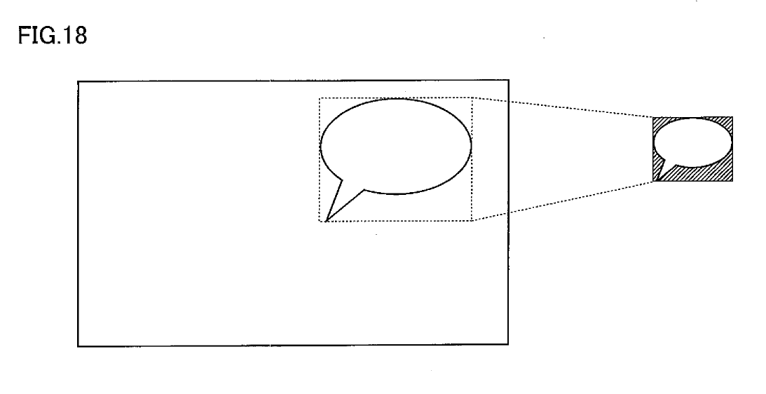

When the provisional scale is stored, differently-colored image data formation unit 640 forms the bit map data representing the differently-colored image and causes data storage unit 300 to temporarily store the same (step S522). FIG. 18 is a conceptual diagram showing the bit map data formed here.

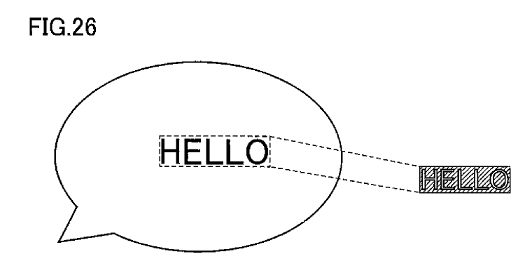

When such bit map data is formed, reduced character image data formation unit 642 forms the bit map data of the reduced character image and causes data storage unit 300 to temporarily store the same (step S524). FIG. 26 is a conceptual diagram showing the bit map data of the reduced character image colored in two different colors that is formed here.

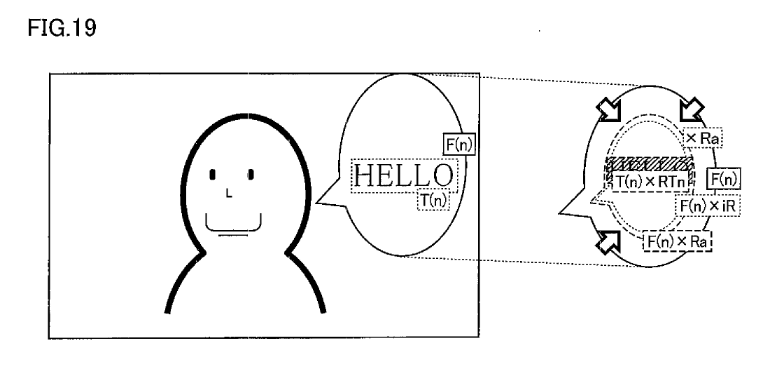

When such bit map data is formed, pixel setting unit 644 determines whether the reduced text region extends off the balloon region or not (step S526). FIG. 19 is a conceptual diagram showing a determination method performed by pixel setting unit 644 in this step. FIG. 19 shows that the balloon shown with long dashed line and indicated with three arrows indicates the balloon reduced at a provisional scale Ra. The balloon shown with short dashed line indicates the balloon reduced at designated scale iR. The hatched rectangle represents the text region reduced at text region reduction scale RTn. In FIG. 19, as the text region does not extend off the balloon region reduced at provisional scale Ra (NO in step S526), provisional value selection unit 646 outputs provisional scale Ra to image processing unit 352 as balloon region reduction scale RFn (RFn=Ra) (step S530).

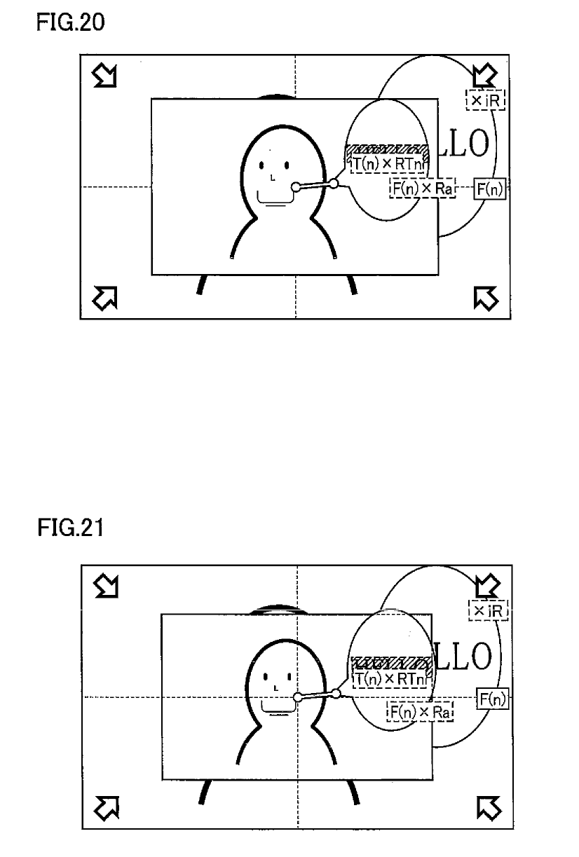

When balloon region reduction scale RFn is output, first proximity point calculation unit 660 calculates the position of the proximity point (step S490). When that point is calculated, fourth designated scale selection unit 666 determines whether the balloon region remains inside the reduced comic image or not (step S492). Here, as it is assumed that the balloon region remains inside the reduced comic image (YES in step S492), fourth designated scale selection unit 666 causes data storage unit 300 to temporarily store the value stored as the designated scale, as the candidate value for comic image reduction scale RiM (step S494). FIG. 20 is a conceptual diagram showing the processed image when the balloon region is reduced at provisional scale Ra. An outer edge of the balloon comes in contact with an outer edge of the processed image.

When the candidate value for comic image reduction scale RiM is stored, the processing after step S476 is performed.

[Example where the Balloon Region does not Remain Inside the Reduced Comic Image]

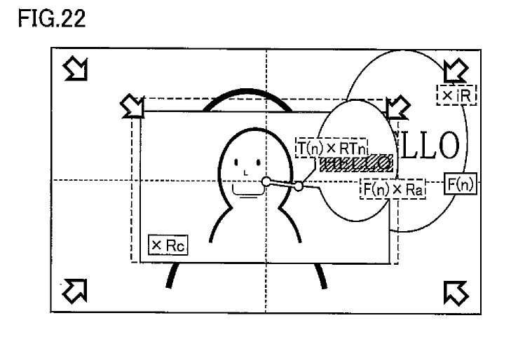

After the processing until step S490, fourth designated scale selection unit 666 determines whether the balloon region remains inside the reduced comic image or not (step S492). Here, as it is assumed that the balloon region does not remain inside the reduced comic image (NO in step 8492), fifth designated scale selection unit 676 determines whether the text region remains inside the reduced comic image or not (step S496). FIG. 21 is a conceptual diagram showing the content of this determination. As shown in FIG. 21, as it is assumed that the outer edge of the text region comes in contact with the outer edge of the reduced comic image (YES in step S496), data storage unit 300 modifies the positional information on the boundary of the balloon region in accordance with the reduced comic image (step S498). FIG. 22 is a conceptual diagram showing this modification. The end of the balloon region has matched with the end of the reduced comic image and the proximity point has been moved. When the positional information is modified, the processing after step S494 is performed.

[Example where the Text Region Extends Off the Reduced Comic Image]

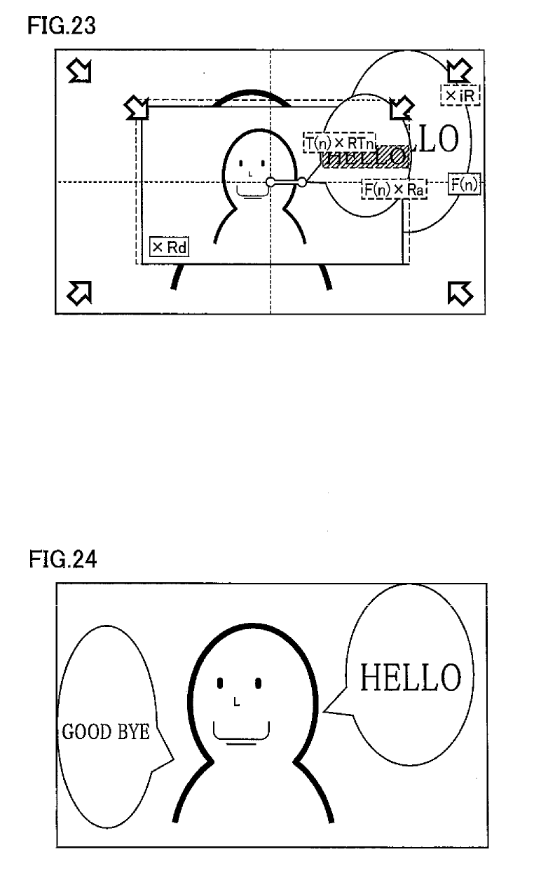

After the processing until step S492, fifth designated scale selection unit 676 determines whether the text region remains inside the reduced comic image or not (step S496). Here, as it is assumed that the text region does not remain inside the reduced comic image (NO in step S496), third reduction scale selection unit 678 calculates the candidate value for comic image reduction scale RiM such that the boundary of the text region matches with the outer edge of the comic image (step S500). FIG. 23 is a conceptual diagram showing this processing. The comic image is reduced to cover a range (scale is set to Rd) shown with dashed line in FIG. 23, not a range showing the processed image in FIG. 23 (scale is set to designated scale iK).

As described above, comic image formation device 100 according to the present embodiment reduces the comic image, the balloon region, and the text region at reduction scales different from each other, and reconstructs these elements. As a result of such reconstruction, for example, lines in the balloon can be displayed at a larger scale and other images can be displayed at a smaller scale. As the lines are thus displayed at a relatively larger scale, the user who views the reduced processed image can readily know what is written. It is not necessary for a provider of the comic image to prepare lines as text data, or to communicate or distribute the comic image together with attached text data. As the image is initially reduced for use, it is not necessary either to form image data of high resolution as in the case where the image is expanded. Consequently, the comic image formation device with less restriction on performance, requiring less effort for forming the image data and allowing the user to obtain much information from the image, can be provided.

In a first variation of the present embodiment, the input image data may include a plurality of balloons. FIG. 24 is a diagram showing an example of such a comic image.

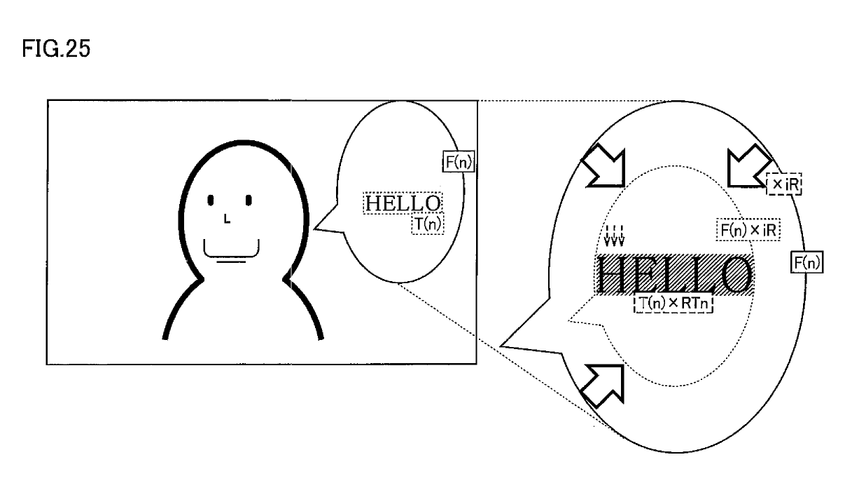

In addition, in a second variation of the present embodiment, in step S470, second designated scale selection unit 620 may determine whether or not the image of the character (not the text region) reduced at text region reduction scale RTn remains inside the balloon when the balloon region is reduced at the designated scale. FIG. 25 is a conceptual diagram showing a determination method in determining whether the image of the character reduced at text region reduction scale RTn remains inside the balloon or not. The balloon shown with short dashed line and indicated with arrows indicates the balloon reduced at the designated scale. Though the text region reduced at text region reduction scale RTn extends off the balloon, the character in the text region does not extend off the balloon.

Here, whether the image of the character reduced at text region reduction scale RTn remains inside the balloon or not is determined through the following procedure, instead of the third procedure and the fourth procedure described above (the fifth procedure described above is not performed). The procedure performed instead of the third procedure is a procedure for forming bit map data of the image obtained by reducing the text region at text region reduction scale RTn. The image may be colored in two different colors, based on whether a pixel constitutes the character or not. FIG. 26 is a conceptual diagram showing the image in such an example.

The procedure performed instead of the fourth procedure is a procedure for comparing pixels identical in the position relative to the center of the text region in the image represented by the bit map data formed in the first procedure and the image represented by the bit map data formed in the procedure performed instead of the third procedure. If these pixels are identical in color, it means that the image of the character extends off the balloon. If the image of the character remains inside the balloon, the process proceeds to step S472. Otherwise, the process proceeds to step S480.

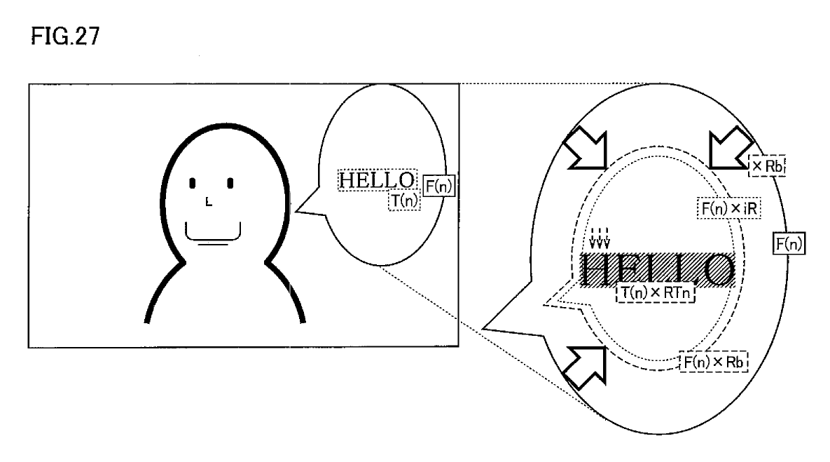

In addition, in a third variation of the present embodiment, in step S526, reduction scale setting unit 340 may determine whether or not the character extends off the balloon region reduced at a provisional scale Rb. A specific determination method is the same as in the second variation described above. Here, when the character extends off the balloon region, the process proceeds to step S528. Otherwise, the process proceeds to step S530. FIG. 27 is a conceptual diagram showing a determination method in determining whether the character extends off the balloon region reduced at provisional scale Rb or not.

Moreover, in a fourth variation of the present embodiment, in accepting designation of a graphic in step S402, the displayed comic image may not be the comic image itself represented by the comic image data but may be the reduced comic image. Here, in order to detect the graphic, the image data of the reduced image is formed in advance and the graphic is detected based on the formed data. Such processing is performed in order to facilitate detection of the graphic, because discontinuity of the balloon in the comic image before reduction is eliminated in the reduced image.

Further, in a fifth variation of the present embodiment, text region reduction scale RTn, balloon region reduction scale RFn, and the comic image reduction scale may indicate a ratio of a size of an image before reduction to a size of the reduced image. In such a case, it is necessary to modify the content or the like of determination in the processing described above depending on definition of these reduction scales.

### Second Embodiment

A comic image formation device according to the second embodiment of the present invention will be described hereinafter.

As the hardware configuration of comic image formation device 100 according to the present embodiment is the same as in the first embodiment described previously and the functions thereof are also the same, detailed description thereof will not be repeated here.

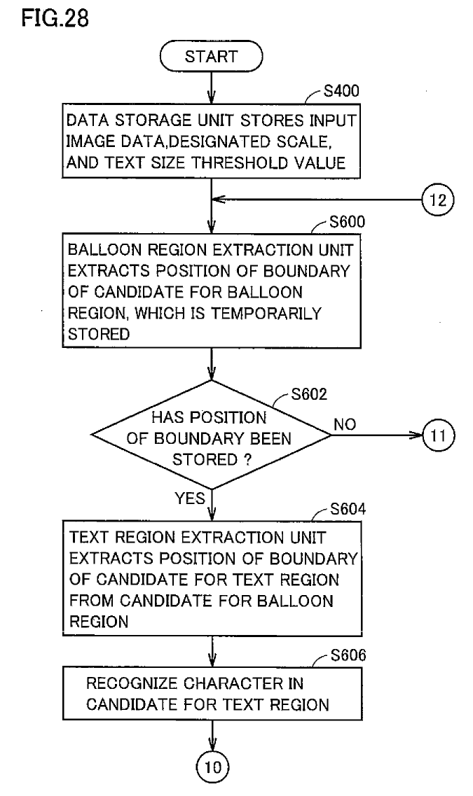

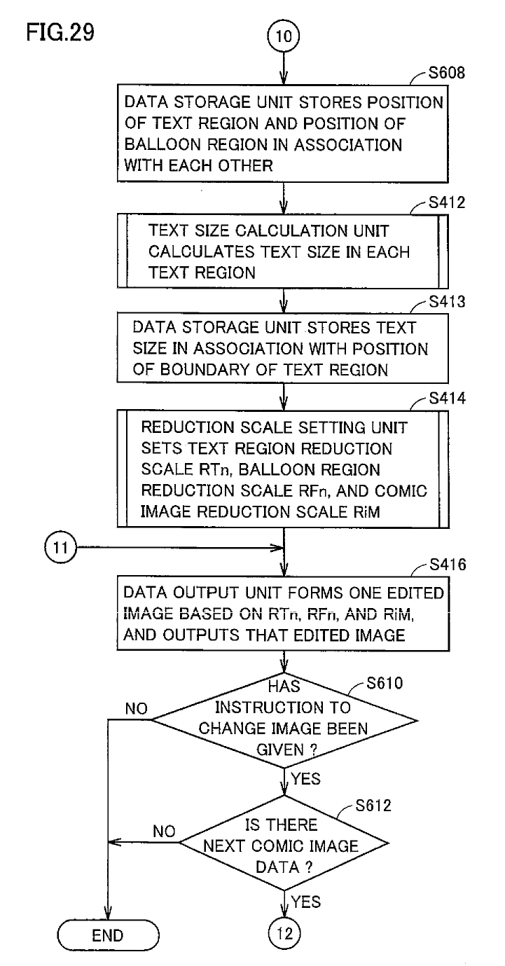

Referring to FIGS. 28 and 29, the program executed in comic image formation device 100 carries out the following control in connection with generation of the processed image. It is noted that the processing in the flowcharts shown in FIGS. 28 and 29, that has been shown in FIGS. 8 and 9 described previously, has the same step number allotted and the functions thereof are also the same. Therefore, detailed description thereof will not be repeated here.

In step S600, balloon region extraction unit 310 extracts a position of a boundary of a region to serve as the candidate for the balloon region and causes data storage unit 300 to temporarily store the same. In the present embodiment, balloon region extraction unit 310 automatically detects a graphic included in the comic image and extracts a position of a boundary of a region circumscribing the graphic.

In step S602, text region extraction unit 320 determines whether the position of the boundary of the region to serve as the balloon region has been stored or not. When it is determined that the position has been stored (YES in step S602), the process proceeds to step S604. Otherwise (NO in step S602), data storage unit 300 stores a value equal to designated scale iR as text region reduction scale RTn, balloon region reduction scale RFn, and comic image reduction scale RiM. When it is stored, the process proceeds to step S416.

In step S604, text region extraction unit 320 extracts the positional information on the boundary of the region to serve as the candidate for the text region from the region to serve as the candidate for the balloon region.

In step S606, a character recognition unit 334 recognizes the character in the region of which positional information has been extracted in step S604.

In step S608, data storage unit 300 stores in association with each other, the position of the boundary of the region in which character has been recognized in step S606 in the region to serve as the candidate for the text region and the position of the boundary of the candidate for the balloon region including that region. Thus, the candidate for the text region and the candidate for the balloon region serve as the text region and the balloon region, respectively.

In step S610 balloon region extraction unit 3 10 determines whether a new processed image should be generated or not based on the instruction accepted by input unit 130. When it is determined that the processed image is to be generated (YES in step S610), the process proceeds to step S612. Otherwise (NO in step S610), the process ends.

In step S612, balloon region extraction unit 310 determines whether there is a next comic image or not. When it is determined that there is such a comic image (YES in step S612), the process proceeds to step S600. Otherwise (NO in step S612), the process ends.

An operation of comic image formation device 100 based on the structure and the flowchart as above will be described.

After the processing in step S400, balloon region extraction unit 310 extracts the position of the boundary of the candidate for the balloon region and causes data storage unit 300 to temporarily store the same (step S600).

When the position is temporarily stored, text region extraction unit 320 determines whether the positional information has been stored in data storage unit 300 or not (step S602). Here, as it is assumed that the positional information has been stored (YES in step S602), text region extraction unit 320 extracts the position of the boundary of the region to serve as the candidate for the text region from the region to serve as the candidate for the balloon region (step S604). When the position is extracted, character recognition unit 334 recognizes the character displayed in that region (step S606). When the character is recognized, data storage unit 300 stores the position of the boundary of the text region and the position of the boundary of the balloon region in association with each other (step S608). When they are stored, after the processing from step S412 to step S416, balloon region extraction unit 310 determines whether a new processed image should be generated or not (step S610). Here, as it is assumed that the new processed image is not to be generated (NO in step S610), the process ends.

As described above, comic image formation device 100 according to the present embodiment automatically detects the balloon based on whether the text region in which character can be recognized is included or not. Thus, the balloon in the comic image can accurately be detected and lines in the balloon can be reduced at an appropriate reduction scale, without user's designation of the balloon each time. Efforts for displaying the image can thus be lessened.

<Variation of Text Size Calculation Unit>

A variation of text size calculation unit 330A common to the first embodiment and the second embodiment will be described hereinafter.

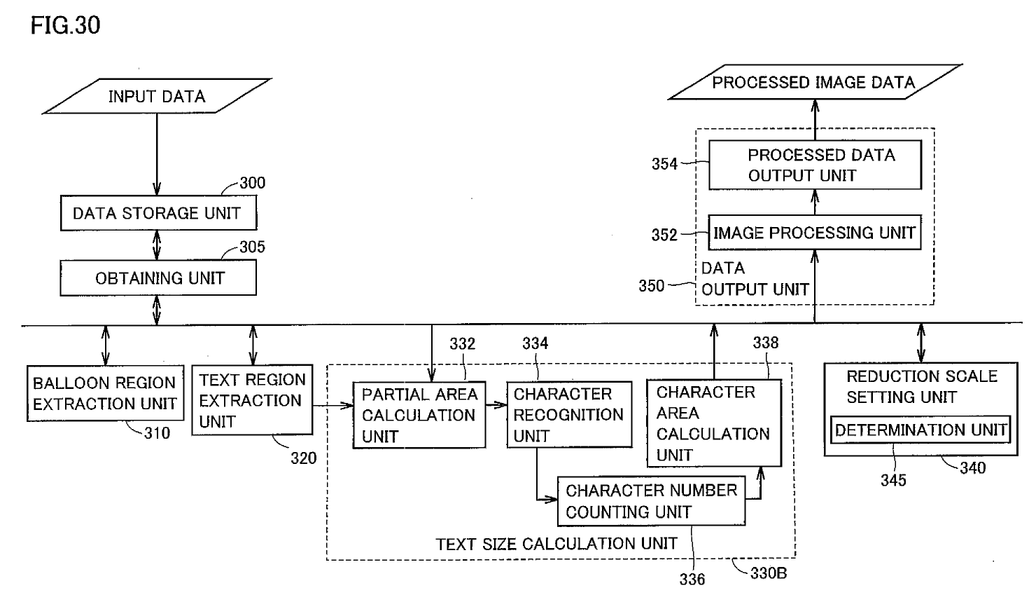

As shown in FIG. 30, a text size calculation unit 330B according to the present variation includes a partial area calculation unit 332, character recognition unit 334, a character number counting unit 336, and a character area calculation unit 338. Partial area calculation unit 332 calculates an area of the text region based on positional information on the boundary of the text region output by text region extraction unit 320. Character recognition unit 334 recognizes the character represented by the image of the text region and generates text data representing the recognized character. Character number counting unit 336 counts the number of characters represented by the image included in the text region based on the text data generated by character recognition unit 334. Character area calculation unit 338 calculates an area per one character by dividing the area of the text region calculated by partial area calculation unit 332 by the number of characters counted by character number counting unit 336. In the present embodiment, this area is handled as the text size. Here, as specific processing for recognizing the characters, specific processing for counting the number of characters, or the like is well known, detailed description thereof will not be repeated.

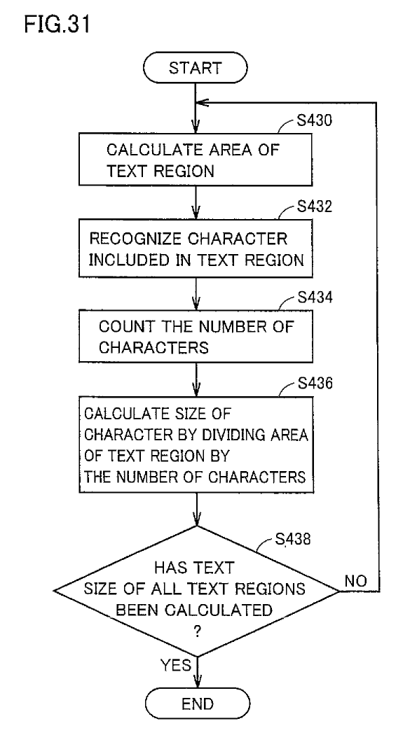

Referring to FIG. 31, the program executed in comic image formation device 100 according to the present variation carries out the following control in connection with calculation of the text size.

In step S430, partial area calculation unit 332 calculates the area of the text region based on the positional information on the boundary of the text region stored in data storage unit 300. The unit of the area is not particularly limited and can be set to any unit by a designer of comic image formation device 100.

In step S432, character recognition unit 334 recognizes the character represented in the text region. The text region where the character is recognized refers to a portion of which area has been calculated by partial area calculation unit 332. When the character is recognized, character recognition unit 334 generates text data representing the recognized character. The text data is temporarily stored in data storage unit 300.

In step S434, character number counting unit 336 counts the number of characters represented by the text data temporarily stored in data storage unit 300. The data representing the number of characters is temporarily stored in data storage unit 300.

In step S436, character area calculation unit 338 calculates the area per one character by dividing the area of the text region stored in data storage unit 300 by the number of characters similarly stored in data storage unit 300. This area is handled as the text size in the present embodiment. Data storage unit 300 stores the text size calculated by character area calculation unit 338 in association with the position of the boundary of the text region used for calculating the text size.

In step S438, partial area calculation unit 332 determines whether the text size of all text regions of which positional information on the boundary is stored in data storage unit 300 has been calculated or not. When it is determined that the text size has been calculated (YES in step S438), the process ends. Otherwise (NO in step S438), the process proceeds to step S430.

### Other Embodiments

The present invention is naturally applicable also to an example where the invention is achieved by supplying a program to a system or a device. An effect of the present invention can be obtained also by supply of a storage medium storing a program expressed by software for achieving the present invention to a system or a device and by reading and execution of a program code stored in the storage medium by a computer (or a CPU or an MPU) of the system or the device.

Here, the program code itself read from the storage medium implements the functions in the embodiments described previously, and the storage medium storing the program code implements the present invention.

For example, a flexible disk, a hard disk, an optical disk, a magneto-optical disk, a CD-ROM, a CD-R, a magnetic tape, a non-volatile memory card (IC memory card), a ROM (mask ROM, flash EEPROM, and the like), and the like can be employed as the storage medium for supplying a program code.

In addition, the present invention is applicable not only to an example where the computer executes the read program code to implement the functions in the embodiments described previously but also to an example where an OS (operating system) operating on the computer or the like partially or entirely performs actual processing based on an instruction from the program code to implement the functions in the embodiments described previously through the processing.

Moreover, the present invention is also applicable to an example where the program code read from the storage medium is written into a memory included in a function expansion board inserted in the computer or a function expansion unit connected to the computer, and thereafter a CPU or the like included in the function expansion board or the function expansion unit partially or entirely performs actual processing based on an instruction from the program code to implement the functions in the embodiments described previously through the processing.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image formation device, comprising:
an obtaining unit obtaining an input image and a first reduction scale;
a first extraction unit extracting a first region including a character from said input image;
a first determination unit determining whether a size of said character reduced at said first reduction scale is equal to or greater than a first size;
a first setting unit setting a second reduction scale greater than said first reduction scale when the size of said character is smaller than said first size; and
a formation unit forming a first processed image by reducing said input image at said first reduction scale when the size of said character is equal to or greater than said first size, and forming a second processed image by reducing said first region at said second reduction scale based on said input image when the size of said character is smaller than said first size.

2. The image formation device according to claim 1, further comprising a first calculation unit calculating the size of said character, wherein
said first calculation unit includes
a generation unit generating a histogram of color distribution in at least any of a horizontal direction and a vertical direction of said first region,
a second calculation unit calculating at least any of a width and a height of the character within said first region based on said histogram, and
a second setting unit setting at least any of the width and the height of the character within said first region as the size of said character.

3. The image formation device according to claim 1, further comprising a third calculation unit calculating the size of said character, wherein
said third calculation unit includes
an area calculation unit calculating an area of said first region,
a character recognition unit recognizing the character within said first region,
a counting unit counting number of characters recognized by said character recognition unit, and
a division unit dividing said area by the number of said characters to calculate the size of said character.

4. The image formation device according to claim 1, wherein
when the size of said character is smaller than said first size, said formation unit forms said second processed image by reducing said first region at said second reduction scale and reducing said input image except for said first region at any of said first reduction scale and said second reduction scale.

5. The image formation device according to claim 1, wherein
said first setting unit sets a third reduction scale greater than said first reduction scale when the size of said character is smaller than said first size, and
when the size of said character is smaller than said first size, said formation unit forms said second processed image by reducing said first region at said second reduction scale and reducing said input image except for said first region at said third reduction scale.

6. An image formation method, comprising the steps of
obtaining an input image and a first reduction scale;
extracting a first region including a character from said input image;
determining whether a size of said character reduced at said first reduction scale is equal to or greater than a first size;
setting a second reduction scale greater than said first reduction scale when the size of said character is smaller than said first size;
forming a first processed image by reducing said input image at said first reduction scale when the size of said character is equal to or greater than said first size; and
forming a second processed image by reducing said first region at said second reduction scale based on said input image when the size of said character is smaller than said first size.

7. The image formation method according to claim 6, further comprising the steps of:
generating a histogram of color distribution in at least any of a horizontal direction and a vertical direction of said first region,
calculating at least any of a width and a height of the character within said first region based on said histogram, and
setting at least any of the width and the height of the character within said first region as the size of said character.

8. The image formation method according to claim 6,i further comprising the steps of:
calculating an area of said first region,
recognizing the character within said first region,
counting number of characters recognized in said step of recognizing the character, and
dividing said area by the number of said characters to calculate the size of said character.

9. The image formation method according to claim 6, wherein
said step of forming a second processed image includes the step of forming said second processed image by reducing said first region at said second reduction scale and reducing said input image except for said first region at any of said first reduction scale and said second reduction scale when the size of said character is smaller than said first size.

10. The image formation method according to claim 6, further comprising the step of setting a third reduction scale greater than said first reduction scale when the size of said character is smaller than said first size, wherein
said step of forming a second processed image includes the step of forming said second processed image by reducing said first region at said second reduction scale and reducing said input image except for said first region at said third reduction scale when the size of said character is smaller than said first size.

11. A computer-readable recording medium recording an image formation program for causing an image formation device having an operational processing unit to form an image, said image formation program causing said operational processing unit to perform the steps of:
obtaining an input image and a first reduction scale;
extracting a first region including a character from said input image;
determining whether a size of said character reduced at said first reduction scale is equal to or greater than a first size;
setting a second reduction scale greater than said first reduction scale when the size of said character is smaller than said first size;
forming a first processed image by reducing said input image at said first reduction scale when the size of said character is equal to or greater than said first size; and
forming a second processed image by reducing said first region at said second reduction scale based on said input image when the size of said character is smaller than said first size.
